(19) United States
(12) Patent Application Publication
(10) Pub. No.: US 2023/0091628 A1
(43) Pub. Date: Mar. 23, 2023

(54) MULTIPLEXING SIDELINK POSITIONING REFERENCE SIGNALS AND DATA

(71) Applicant: QUALCOMM Incorporated, San Diego, CA (US)

(72) Inventors: Wooseok Nam, San Diego, CA (US); Yucheng Dai, San Diego, CA (US); Tao Luo, San Diego, CA (US); Jing Sun, San Diego, CA (US); Junyi Li, Fairless Hills, PA (US); Peter Gaal, San Diego, CA (US); Sony Akkarakaran, Poway, CA (US); Juan Montojo, San Diego, CA (US); Srinivas Yerramalli, San Diego, CA (US)

(21) Appl. No.: 17/481,663

(22) Filed: Sep. 22, 2021

(51) Int. Cl. H04W 72/04; H04L 5/00; G01S 5/00; H04W 72/12; H04L 1/00

(52) U.S. Cl. CPC H04W 72/048; H04L 5/0048; G01S 5/0072; H04W 72/1263; H04L 1/0067; H04W 72/1278; H04W 72/0406; H04W 72/0446

(57) ABSTRACT

Methods, systems, and devices for wireless communication are described. A user equipment (UE) may identify one or more sidelink positioning reference signal burst patterns identifying one or more bursts of sidelink positioning reference signals that are to be transmitted by either the UE or by other sidelink UEs. The UE may schedule transmission of a sidelink data message to occur during a same time period that includes the one or more bursts of sidelink positioning reference signals. The UE may transmit the sidelink data message via first resource elements that are different from second resource elements on which the one or more bursts of sidelink positioning reference signals are transmitted.

### FIELD OF TECHNOLOGY

The following relates to wireless communication, including multiplexing sidelink positioning reference signals and data.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support multiplexing sidelink positioning reference signal(s) (PRS)(s) and data. Generally, the described techniques provide a mechanism where sidelink user equipment (UE) may multiplex sidelink data messages with sidelink PRS bursts. In one scenario, a sidelink UE may determine that it is to transmit both a sidelink data message and also a PRS burst. In this scenario, since the UE is aware of its PRS burst pattern, the UE may select and schedule resources for its data transmission in view of the PRS burst pattern. The sidelink data transmission may be rate-matched around the PRS resources. In some instances, portions of either the PRS burst or the data transmission may be punctured. In another scenario, a sidelink UE may determine that it is to transmit a sidelink data message at a same time that other sidelink UE(s) are transmitting PRS bursts. In this scenario, the data-transmitting UE coordinates with the other UEs to determine the PRS burst patterns, and then transmits the data multiplexed with the PRS transmissions from the other UEs. The coordination may be through an exchange of signals, including sidelink control information (SCI) messages. The data-transmitting UE may also signal a zero-power reference signal transmission on resources used by the other UEs for the PRS transmissions, thus providing a rate-matching or puncturing map for a receiving UE.

A method for wireless communication at a UE is described. The method may include identifying one or more sidelink PRS burst patterns identifying one or more bursts of sidelink PRSs that are to be transmitted by either the UE or by other sidelink UEs, scheduling transmission of a sidelink data message to occur during a same time period that includes the one or more bursts of sidelink PRSs, and transmitting the sidelink data message via first resource elements that are different from second resource elements on which the one or more bursts of sidelink PRSs are transmitted.

An apparatus for wireless communication at a UE is described. The apparatus may include a processor, memory coupled with the processor, and instructions stored in the memory. The instructions may be executable by the processor to cause the apparatus to identify one or more sidelink PRS burst patterns identifying one or more bursts of sidelink PRSs that are to be transmitted by either the UE or by other sidelink UEs, scheduling transmission of a sidelink data message to occur during a same time period that includes the one or more bursts of sidelink PRSs, and transmit the sidelink data message via first resource elements that are different from second resource elements on which the one or more bursts of sidelink PRSs are transmitted.

Another apparatus for wireless communication at a UE is described. The apparatus may include means for identifying one or more sidelink PRS burst patterns identifying one or more bursts of sidelink PRSs that are to be transmitted by either the UE or by other sidelink UEs, means for scheduling transmission of a sidelink data message to occur during a same time period that includes the one or more bursts of sidelink PRSs, and means for transmitting the sidelink data message via first resource elements that are different from second resource elements on which the one or more bursts of sidelink PRSs are transmitted.

A non-transitory computer-readable medium storing code for wireless communication at a UE is described. The code may include instructions executable by a processor to identify one or more sidelink PRS burst patterns identifying one or more bursts of sidelink PRSs that are to be transmitted by either the UE or by other sidelink UEs, scheduling transmission of a sidelink data message to occur during a same time period that includes the one or more bursts of sidelink PRSs, and transmit the sidelink data message via first resource elements that are different from second resource elements on which the one or more bursts of sidelink PRSs are transmitted.

A method for wireless communication at a first UE is described. The method may include identifying one or more sidelink PRS burst patterns identifying one or more bursts of sidelink PRSs to be transmitted by respective sidelink UEs, receiving, from a second UE, a sidelink data message during a same time period that includes the one or more bursts of sidelink PRSs, the sidelink data message received via first resource elements that are different from second resource elements on which the one or more bursts of sidelink PRSs are received, and determining a position of the first UE based on receiving the one or more bursts of sidelink PRSs.

An apparatus for wireless communication at a first UE is described. The apparatus may include a processor, memory coupled with the processor, and instructions stored in the memory. The instructions may be executable by the processor to cause the apparatus to identify one or more sidelink PRS burst patterns identifying one or more bursts of sidelink PRSs to be transmitted by respective sidelink UEs, receive, from a second UE, a sidelink data message during a same time period that includes the one or more bursts of sidelink PRSs, the sidelink data message received via first resource elements that are different from second resource elements on which the one or more bursts of sidelink PRSs are received, and determine a position of the first UE based on receiving the one or more bursts of sidelink PRSs.

Another apparatus for wireless communication at a first UE is described. The apparatus may include means for identifying one or more sidelink PRS burst patterns identifying one or more bursts of sidelink PRSs to be transmitted by respective sidelink UEs, means for receiving, from a second UE, a sidelink data message during a same time period that includes the one or more bursts of sidelink PRSs, the sidelink data message received via first resource elements that are different from second resource elements on which the one or more bursts of sidelink PRSs are received, and means for determining a position of the first UE based on receiving the one or more bursts of sidelink PRSs.

A non-transitory computer-readable medium storing code for wireless communication at a first UE is described. The code may include instructions executable by a processor to identify one or more sidelink PRS burst patterns identifying one or more bursts of sidelink PRSs to be transmitted by respective sidelink UEs, receive, from a second UE, a sidelink data message during a same time period that includes the one or more bursts of sidelink PRSs, the sidelink data message received via first resource elements that are different from second resource elements on which the one or more bursts of sidelink PRSs are received, and determine a position of the first UE based on receiving the one or more bursts of sidelink PRSs.

### BRIEF DESCRIPTION OF THE DRAWINGS

FIG. 1 illustrates an example of a wireless communications system that supports multiplexing sidelink positioning reference signals (PRS) and data in accordance with aspects of the present disclosure.

FIG. 2 illustrates an example of a wireless communication system that supports multiplexing sidelink PRS and data in accordance with aspects of the present disclosure.

FIG. 3 illustrates an example of a PRS configuration that supports multiplexing sidelink PRSs and data in accordance with aspects of the present disclosure.

FIG. 4 illustrates an example of a PRS configuration that supports multiplexing sidelink PRS and data in accordance with aspects of the present disclosure.

FIGS. 5 and 6 show block diagrams of devices that support multiplexing sidelink PRS and data in accordance with aspects of the present disclosure.

FIG. 7 shows a block diagram of a communications manager that supports multiplexing sidelink PRS and data in accordance with aspects of the present disclosure.

FIG. 8 shows a diagram of a system including a device that supports multiplexing sidelink PRS and data in accordance with aspects of the present disclosure.

FIGS. 9 through 13 show flowcharts illustrating methods that support multiplexing sidelink PRS and data in accordance with aspects of the present disclosure.

### DETAILED DESCRIPTION

Some wireless communication systems support the transmission of positioning reference signals (PRSs) to assist a user equipment (UE) in determining its location. While PRSs have traditionally been transmitted by base stations, PRSs could also be transmitted by sidelink UEs. For example, a sidelink UE may transmit a sidelink control block indicating information pertaining to the sidelink PRS transmissions (e.g., time and/or frequency domain resource allocations). The sidelink UE may subsequently transmit the sidelink PRSs according to the time and/or frequency domain resource allocations. Other UEs may receive the sidelink control block and associated sidelink PRS transmissions and use the sidelink PRS transmissions to determine their respective positions. Currently, no procedures have been defined for the simultaneous transmission of a data message from a sidelink UE while a PRS burst is also transmitted, either by the same sidelink UE or by other UEs.

Generally, the described techniques provide a mechanism where sidelink UE may multiplex sidelink data messages with sidelink PRS bursts. In one scenario, a sidelink UE may determine that it is to transmit both a sidelink data message and also a PRS burst. In this scenario, since the UE is aware of its PRS burst pattern, the UE may select and schedule resources for its data transmission in view of the PRS burst pattern. The sidelink data transmission may be rate-matched around the PRS resources. In some instances, portions of either the PRS burst or the data transmission may be punctured. In another scenario, a sidelink UE may determine that it is to transmit a sidelink data message at a same time that other sidelink UE(s) are transmitting PRS bursts. In this scenario, the data-transmitting UE coordinates with the other UEs to determine the PRS burst patterns, and then transmits the data multiplexed with the PRS transmissions from the other UEs. The coordination may be through an exchange of signals, including sidelink control information (SCI) messages. The data-transmitting UE may also signal a zero-power reference signal transmission on resources used by the other UEs for the PRS transmissions, thus providing a rate-matching or puncturing map for a receiving UE.

Aspects of the disclosure are initially described in the context of wireless communications systems. Aspects of the disclosure are further illustrated by and described with reference to apparatus diagrams, system diagrams, and flowcharts that relate to multiplexing sidelink PRS and data.

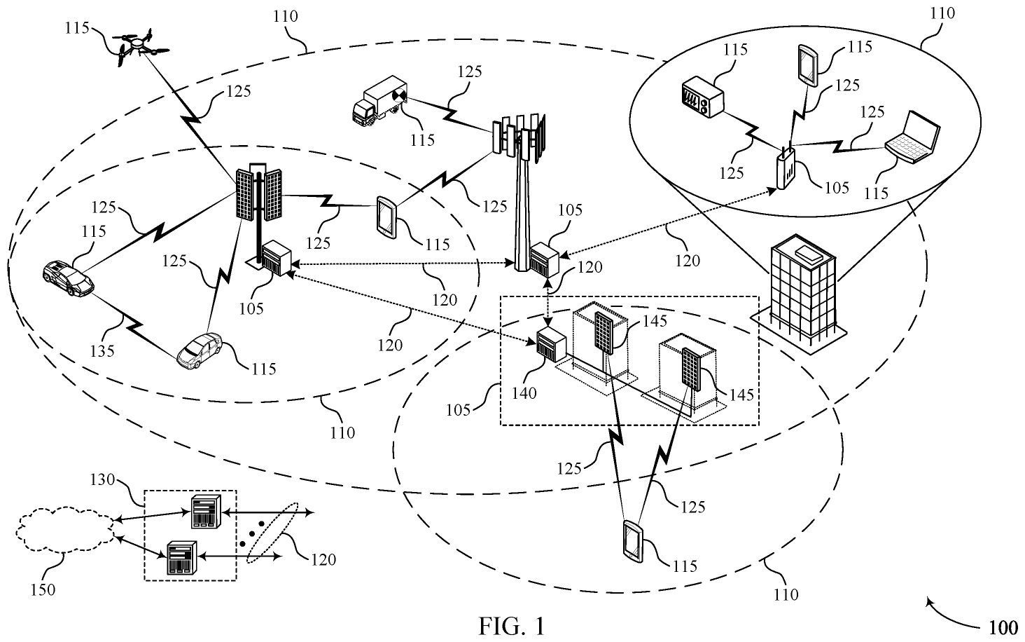

FIG. 1 illustrates an example of a wireless communications system 100 that supports multiplexing sidelink PRS and data in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A UE 115 may identify one or more sidelink PRS burst patterns identifying one or more bursts of sidelink PRS that are to be transmitted by either the UE 115 or by other sidelink UEs. The UE 115 may schedule transmission of a sidelink data message to occur during a same time period that includes the one or more bursts of sidelink PRS. The UE 115 may transmit the sidelink data message via first resource elements that are different from second resource elements on which the one or more bursts of sidelink PRS are transmitted.

A UE 115 may identify one or more sidelink PRS burst patterns identifying one or more bursts of PRS to be transmitted by respective sidelink UEs. The UE 115 may receive, from a second UE, a sidelink data message during a same time period that includes the one or more bursts of sidelink PRS, the sidelink data message received via first resource elements that are different from second resource elements on which the one or more bursts of sidelink PRS are received. The UE 115 may determine a position of the first UE based at least in part on receiving the one or more bursts of sidelink PRS.

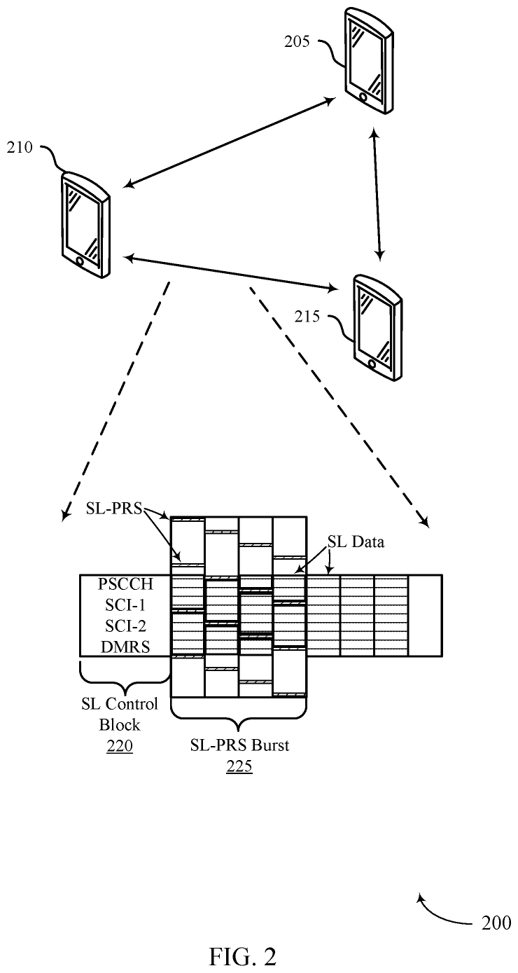

FIG. 2 illustrates an example of a wireless communication system 200 that supports multiplexing sidelink PRS resources in accordance with aspects of the present disclosure. The wireless communication system 200 may implement or be implemented to realize aspects of the wireless communications system 100. For example, wireless communication system 200 may illustrate communication between a set of UEs (including a UE 205, a UE 210, or a UE 215). In some implementations, the UE 205, the UE 210, and the UE 215 may be examples of UEs 115 as described herein, including with reference to FIG. 1.

Wireless communication system 200 may support procedures and channel structures that devices (any one or more of the UEs) may use to facilitate an acquisition of positioning or ranging information, including one or more aspects of sidelink positioning. For example, a UE (any one or more of the UE 205, the UE 210, or the UE 215) may receive a Uu-PRS via a Uu communications link between the UE 115 and a BS, or may receive an SL-PRS burst 225 via a sidelink between the UE and another UE (such as a UE 210 that is an example of or functions as a sidelink anchor node), or may receive both a Uu-PRS and an SL-PRS burst 225. A sidelink anchor node, which may be refer to a UE that transmits an SL-PRS 220, may be any UE 115 associated with suitably accurate position information (for example, that already has accurate knowledge of its position), such as position information obtained from a global navigation satellite system (GNSS) or prior PRS signaling.

The transmission of SL-PRSs 220 may support a higher quantity of PRS transmitters (for example, using more LOS links), or a greater diversity of PRS transmitter locations, which may improve accuracy of UE positioning across various deployment scenarios and in various channel conditions. For example, for a UE with poor channel conditions (such as a UE having relatively few or no LOS Uu links), the transmission of SL-PRSs 220 from a sidelink anchor node may increase a quantity of LOS links over which the UE may receive a PRS (either or both of Uu-PRSs or SL-PRSs 220, where a total quantity of LOS links includes Uu and sidelink LOS links). In some implementations, such as in indoor factory deployments, a lack of or relatively few LOS links may be relatively common. For example, for some indoor factory channels (such as channels used for indoor factory-dense high or -dense low (InF-DH/DL) deployments), devices may have a relatively low probability for LOS links as a result of relative positioning of various devices and the potential for obstruction. For UEs with good channel conditions (such as a UE having a relatively large amount of LOS links), the additional ability to receive SL-PRSs 220 via SL LOS links (e.g., a PC5 interface) may improve overall positioning accuracy by additional measurements (for example, as a result of receiving and measuring more SL-PRSs 220). In some implementations, an increase in Uu or sidelink LOS links may support power efficient P2P positioning or ranging for various uses or deployment scenarios, such as public safety uses.

Additionally, or alternatively, a UE may perform sidelink “sensing” (positioning for a device-free object), which may be performed in a joint framework with sidelink positioning. For example, a UE may perform sensing to detect a device-free object (such as a passive object that may not have a communication capability) using an SL-PRS 220 (as well as a Uu-PRS, where available) as a radar signal. As such, a UE may perform positioning and sensing in a same framework (such as a same signaling framework), where positioning may be related to or otherwise associated with a measurement of one or more LOS components of a PRS, and sensing may be related to or otherwise associated with a measurement of one or more non-LOS (NLOS) components of a PRS. In some implementations, such one or more NLOS components may refer to a reflection from the object.

A UE may communicate with one or more other UEs in accordance with various sidelink communication or resource allocation modes. For example, one or more components of a base station may configure the UEs to communicate in accordance with a sidelink communication resource allocation Mode 1 or a sidelink communication resource allocation Mode 2. In examples in which one or more components of the base station configure the UEs to communicate in accordance with the sidelink communication or resource allocation Mode 1, one or more components of the base station may schedule sidelink communication between the UEs may allocate resources for the UEs to perform the scheduled communication. In examples in which one or more components of the base station configure the UEs to communicate in accordance with the sidelink communication or resource allocation Mode 2, one or more components of the base station may allocate a set of resources (such as a resource pool) for the UEs and the UEs may autonomously schedule sidelink communication using resources from the set of resources (for example, without receiving scheduling information from one or more components of the base station).

In some deployment scenarios (such as in deployment scenarios in which one or more of the UEs are OoC of one or more components of a base station and in which one or more components of the base station configures the UEs for sidelink communication or resource allocation Mode 2), communication between the UEs may rely on distributed coordination among the UEs (for example, the sidelink nodes). For example, the UEs may share a common resource pool for sidelink (SL) communication and each UE may identify or select candidate resources within the common resource pool by channel sensing and exclusion. For example, a UE may select a resource for communication among the candidate resources and may transmit, to one or more other UEs, reservation information indicating that the UE has reserved the selected resource. The one or more other UEs may receive the reservation information, identify the reserved resource, and exclude the resource from its own resource selection accordingly.

For sidelink communication in accordance with the sidelink communication or resource allocation Mode 2 (according to which one or more components of a base station refrain from providing scheduling information or controlling communication between the UEs), reference signal transmissions may be aperiodic. In other words, due to the distributed nature of a Mode 2 resource allocation, a UE may transmit a reference signal as a result of or responsive to receiving a request for the reference signal. For example, a UE may receive a message (such as a CSI-request field in SCI-2) triggering a sidelink CSI-RS measurement report. In such examples in which the UE (a designated receiver) receives a CSI-request field in SCI, the UE may receive a CSI-RS along with (such as multiplexed with) data, measure the CSI-RS, and transmit a sidelink CSI-RS measurement report responsive to receiving the CSI-request field and using the CSI-RS measurement. Similarly, a UE may transmit a PRS (an SL-PRS burst 225) as a result of receiving a request for the PRS from another UE. Such a request-based procedure for transmission of SL-PRSs 220 may result in SL-PRSs 220 being sent aperiodically or semi-persistently transmitted. For example, wireless communication system 200 may support on-demand SL-PRS burst 225 such that a UE may transmit an SL-PRS request to one or more other UEs or one or more other devices, such as roadside units (RSUs). A UE transmitting the SL-PRS request may transmit a request via SCI (such as one or both of SCI-1 or SCI-2) or via a MAC-CE. A UE transmitting an SL-PRS request may transmit the request via unicast signaling, broadcast signaling, or multicast signaling. Responsive to receiving an SL-PRS request, a UE may transmit an SL-PRS burst 225 with a staggered comb pattern during a portion of a TTI (such as a slot) and, in some implementations, the TTI may be associated with a slot format that is dedicated for SL-PRS transmissions.

In some implementations, a UE (any of UE 205, UE 210, and/or UE 215, which may be examples of or function as a sidelink anchor node) may transmit an SL-PRS burst 225 following sensing and resource selection procedures, which may implement one or more aspects of such techniques for transmitting other sidelink resource allocation Mode 2 transmissions. To reserve resources for the SL-PRS burst 225, the UE may perform one or more of various resource reservation or pre-emption techniques to obtain sufficient resources for the transmission of the SL-PRS burst 225. For example, a positioning resolution may be associated with (such as correlated with) a sub-channel allocation for an SL-PRS slot during which the UE transmits the SL-PRS 225, where a greater bandwidth for the SL-PRS burst 225 may provide higher resolution positioning or ranging information and, accordingly, a full bandwidth of the allocated resource pool may provide receiving UEs with an upper limit or highest resolution.

In some implementations, to reserve a relatively large sub-channel allocation for the SL-PRS slot, UEs may support a priority ranking for different types of sidelink transmissions, and an SL-PRS slot (or the SL-PRS burst 225) may have a relatively high priority that supports an SL-PRS slot preempting other transmissions in the same slot. As such, the UE may transmit the SL-PRS burst 225 using the SL-PRS slot and over the full bandwidth of the resource pool (as other transmissions that overlap in time with the SL-PRS slot may be pre-empted by the SL-PRS burst 225). Additionally, or alternatively, SCI (such as a first SCI-1) associated with (such as scheduling, which may be indicated in sidelink control block 220) an SL-PRS transmission may reserve resources for the SL-PRS burst 225 in any one or more of a current slot (the slot during which the UE transmits the reserving SCI-1) or one or more future slots. In such implementations in which the UE reserves resources (e.g., via sidelink control block 220) for the SL-PRS burst 225 via SCI (such as SCI-1), the UE may reserve resources in the current slot or in the one or more future slots in a same sub-channel, in different sub-channels, or in another resource pool (such as another resource pool that is frequency division multiplexed with the resource pool allocated for the UE). In other words, the SCI may assign resources for SL-PRS transmissions in a same sub-channel, in different sub-channels, or in another frequency division multiplexed resource pool. In implementations in which the UE performs SL-PRS transmissions in different sub-channels or in another resource pool, the UE may perform the SL-PRS transmissions such that phase continuity is maintained across the transmissions. Further, a receiving UE that receives SL-PRS transmissions over different sub-channels or in other frequency division multiplexed resource pools may combine (for example, stitch together) the multiple SL-PRS transmissions into a wideband SL-PRS burst 225 (and thus may achieve a higher resolution).

In some implementations, the UE may perform the SL-PRS transmissions over a same slot (such that the SL-PRS slots are simultaneous) or within a configured duration (for example, a relatively short duration) and may transmit the SL-PRS burst 225 in different sub-channels or over multiple frequency division multiplexed resource pools. The UE, if performing SL-PRS transmissions across multiple frequency division multiplexed resource pools, may perform the SL-PRS transmissions such that there is phase coherence across the multiple frequency division multiplexed transmissions. Additionally, or alternatively, the UE may use resources at the edge of the allocated resource pool to transmit the SL-PRS burst 225. For example, there may be residual (unoccupied) resources at the edge of the resource pool and the UE may, in addition or as an alternative to using other resources, may use such residual resources for SL-PRS transmissions. Further, although described in the context of aperiodic SL-PRS transmissions, the UE may alternatively perform SL-PRS transmissions periodically or semi-persistently and may use a periodic resource reservation to reserve resources for such periodic or semi-persistent SL-PRS transmissions.

Additionally, or alternatively, the UE may use resources that are dedicated for SL-PRS transmissions. Such dedicated resources may include a resource pool, a set of sub-channels, or a set of slots, or any combination thereof, and the UE may receive an indication (such as a configuration) of the dedicated resources from one or more components of a base station, or the UE may be pre-configured with the dedicated resources (such that the dedicated resources are pre-loaded at the UE and, in some implementations, defined by a specification). In some implementations in which the UE uses resources for SL-PRS transmissions from the resources that are dedicated for SL-PRS transmissions, the UE may transmit one or more SL-PRSs 220 without sensing or reservation. Additionally, or alternatively, a UE may receive a configuration of a measurement gap and may transmit or receive SL-PRSs during the measurement gap. Such a measurement gap may include or otherwise refer to a time duration (for example, a configured duration, a configured periodic interval) during which the UE expects to transmit or receive SL-PRSs and during which the UE does not expect to transmit or receive other sidelink channels, such as a PSSCH.

The UE may transmit the SL-PRS burst 225 via different cast types for different uses. For example, the UE may transmit the SL-PRS burst 225 via unicast signaling (for P2P ranging) or may transmit the SL-PRS burst 225 via multicast signaling or broadcast signaling (for group positioning or sensing). In some implementations, the UE may transmit the SL-PRS burst 225 via a dedicated cast type that is exclusively used for SL-PRS transmissions. Such a dedicated cast type may be referred to as ‘positioning broadcast’ and, accordingly, the UE may transmit the SL-PRS burst 225 via positioning broadcast signaling.

Aspects of the techniques described herein may provide for efficient sharing of frequency resources by multiplexing of multiple SL-PRS burst 225 and sidelink data (e.g., PSSCH) in the same slot. More particularly, aspects of the techniques describe herein may include a UE (e.g., any UE, such as UE 205, UE 210, and/or UE 215) multiplexing its own sidelink data (e.g., PSSCH) with SL-PRS 225 and/or with SL-PRS 225 transmitted by other sidelink UEs. For example, UE 205 may multiplex its PSSCH with SL-PRS burst 225 transmitted by UE 210 and/or UE 215, or vice versa. UE 205, in another example, may multiplex its PSSCH with its own SL-PRS burst 225.

For example, the UE may identify or otherwise determine SL-PRS burst patterns for one or more SL-PRS bursts 225. As discussed, the SL-PRS bursts 225 may be transmitted by the UE and/or may be transmitted by other sidelink UE.

In the situation where the UE determines to multiplex its own PSSCH (e.g., sidelink data message) with its own SL-PRS burst 225, this may include the UE identifying or otherwise determining that it has information to communicate in the sidelink data message. The PSSCH may be a SL-SCH and/or SCI-2, which may carry, convey, or otherwise deliver the SL-PRS information and/or assistance data for positioning/sensing. The PSSCH and/or SL-PRS burst 225 may be unicast transmissions, multicast transmissions, or broadcast transmissions. In some examples, the UE multiplexing its own PSSCH with SL-PRS burst 225 may use one sidelink control block 220 to schedule both the PSSCH and SL-PRS burst 225 or may use separate sidelink control blocks 220 to schedule the PSSCH and SL-PRS burst 225. Multiplexing the PSSCH and SL-PRS burst 225 may include scheduling the PSSCH for transmission on first resource elements and the SL-PRS burst 225 second resource elements (e.g., at the resource element level, tone level, sub-channel level, code level, spatial level, etc.).

That is, in some examples the UE may transmit or otherwise provide a sidelink control block 220 identify the SL-PRS burst pattern (e.g., the TDRA, FDRA, etc.) for the SL-PRS burst 225 that is being scheduled for transmission by the UE. The sidelink control block 220 in this example may also schedule the PSSCH (e.g., identify the resources used for the PSSCH). For example, the sidelink control block 220 in this example may have separate bits, fields, etc., used to indicate the time, frequency, code, spatial, etc., resources for each of the PSSCH being scheduled by the UE and for the SL-PRS burst 225. In other examples, two PSCCHs (e.g., two sidelink control blocks 220) from the same UE may be used to schedule the PSSCH and SL-PRS burst 225 in the same slot. For example, the UE may transmit a first sidelink control block 220 identify scheduling the SL-PRS burst 225 and a second sidelink control block 220 scheduling the PSSCH. The two PSCCHs (e.g., the two sidelink control blocks 220) may be multiplexed in the time domain (e.g., cross-slot scheduling or cross-slot SL-PRS burst 225 triggering) in different slots or multiplexed in the frequency domain in the same slot.

As illustrated in FIG. 2, the co-scheduled PSSCH and SL-PRS burst 225 may have different bandwidths (e.g., in partially overlapping frequency ranges). For example, the UE may identify or otherwise determine first resource elements spanning a first bandwidth that is different from, but may overlap at least to some degree, with a second bandwidth spanned by the second resource elements. Generally, the second resource elements used for the SL-PRS burst 225 are not available for the PSSCH transmission. That is, the PSSCH resource elements (e.g., the first resource elements) allocation may rate match around the SL-PRS resource elements (e.g., the second resource elements) in the overlapping sub-channels, tones, etc. The UE may rate match the transmission of the PSSCH (e.g., the sidelink data message) around the second resource elements allocated for the SL-PRS.

In other examples, the UE may multiplex its PSSCH with SL-PRS burst 225 transmitted from other UE. For example, the UE may receive information pertaining to the SL-PRS burst 225 scheduled by another sidelink UE via network-wide and/or peer-to-peer coordination (e.g., exchanging MAC CE, RRC messaging, etc.) between the UE and the other sidelink UE. In some example, the UE multiplexing its PSSCH may detect (e.g., overhear) a message indicating cross-slot PRS triggering procedure (e.g., a sidelink control message 220) and identify the burst pattern for the SL-PRS burst 225 based on the message. The UE may acquire the information pertaining to the other sidelink UE's SL-PRS burst 225 before scheduling its PSSCH for transmission. As discussed above, the PSSCH may be rate matched around or punctured at the multiplexed SL-PRS burst 225 resource elements. To avoid adjacent channel leakage interference from the high-powered SL-PRS resource elements (e.g., the second resource elements), additional guard resource elements may also be rate matched or punctured. Accordingly, the second resource elements may include a subset of guard resource elements that are not used for transmitting SL-PRS.

In some examples, the UE multiplexing its PSSCH with SL-PRS burst 225 from other UE may rate match the PSSCH transmission around one, some, or all of the second resource elements used for the SL-PRS burst 225. The UE may puncture, using its PSSCH, one or more of the second resource elements used for the SL-PRS burst 225.

In some examples, the UE multiplexing its PSSCH with SL-PRS burst 225 from other sidelink UE may indicate a zero-power reference signal (ZP-SL-PRS) when scheduling its PSSCH. The ZP-SL-PRS resource may have a rate matched pattern with the multiplexed SL-PRS burst 225 (e.g., may indicate a ZP-SL-PRS in the second resource elements within the frequency range of the PSSCH). The ZP-SL-PRS indication may identify the pattern of the rate matched or punctured PSSCH resource element mapping (e.g., may identify the first resource elements. Accordingly, the UE multiplexing its PSSCH with the SL-PRS burst 225 of other sidelink UEs may transmit or otherwise provide an indication of the ZP-SL-PRS pattern that matches the second resource elements (or at least the second resource elements that lie within the bandwidth or frequency range of the first resource elements). The indication, in some examples, may be an index included in an SCI message. That is, an index of the (pre)configured ZP-SL-PRS patterns may be indicated in SCI-1 and/or SCI-2.

In some aspects, the UE multiplexing its PSSCH with its own SL-PRS burst 225 and/or with SL-PRS burst 225 from other sidelink UE may schedule DMRS along with the PSSCH that is multiplexed with SL-PRS burst 225. Various examples of scheduling and/or transmitting the DMRS with the PSSCH may be considered.

One example may include the DMRS being multiplexed with the SL-PRS burst 225 on different tones (e.g., FDM) or with different codes (CDM) during the same symbol. For example, the UE multiplexing its PSSCH with SL-PRS burst 225 may transmit or otherwise provide DMRS(s) associated with the PSSCH multiplexed with the SL-PRS burst 225. The multiplexing in this example may be at the tone level, at the resource element level, at the code level, at the spatial resource level, and the like.

Another example may include the DMRS or SL-PRS burst 225 being punctured at the resource element level, resource block level, sub-channel level, symbol level, etc., in the overlapping frequency range. For example, the UE multiplexing its PSSCH with SL-PRS burst 225 may transmit or otherwise provide its PSSCH DMRS(s) by puncturing at the resource element level, the resource block level, the sub-channel level, the symbol level, etc., at least some of the DMRSs and/or a subset of the SL-PRS burst 225 (e.g., in an overlapping frequency region associated with PSSCH).

Another example may generally prohibit PSSCH DMRS and SL-PRS burst 225 to occur in the same symbol. For example, the sidelink UE may not be expect that the PSSCH DMRS and SL-PRS are on the same symbol. This may include the UE multiplexing its PSSCH with SL-PRS burst 225 identifying or otherwise determining that DMRS(s) associated with the sidelink data message (e.g., PSSCH DMRS(s)) are scheduled during symbol(s) of the first resource elements. In this situation, the UE may refrain from transmitting DMRS(s) during the symbol(s) that the PSSCH are scheduled in (e.g., for the symbols that are scheduled for the SL-PRS burst 225). Moreover, a UE receiving the multiplexed PSSCH and SL-PRS burst 225 may refrain from monitoring for the DMRS(s) during the symbols that the PSSCH are scheduled in.

In some examples, when the SL-PRS burst 225 and PSSCH are multiplexed in the same slot, special considerations for power/AGC may be considered. That is, due to the multiplexed SL-PRS burst 225, there may be symbol level transmit power variations within a slot (e.g., symbol(s) with both PSSCH and SL-PRS multiplexed together may use a higher transmit power. Accordingly, different examples of transmit power/AGC may be used according to the techniques described herein.

A first example may simply be that a receiving UE may retrain its AGC at the first symbol of the multiplexed SL-PRS burst 225. In some aspects, a redundant SL-PRS symbol may be added to support AGC retraining at the beginning of the SL-PRS burst 225. Accordingly, a UE multiplexing its PSSCH with SL-PRS burst 225 may add a first symbol associated with the SL-PRS burst 225 as a power control symbol (e.g., the redundant SL-PRS symbol and/or the regularly scheduled first symbol of the SL-PRS burst 225).

In another example, a power offset between the sidelink control block 220 and the SL-PRS burst 225 may be (pre)configured. A receiving UE may use the power offset to adjust its AGC before and after reception of the multiplexed SL-PRS burst 225. The UE multiplexing its PSSCH with SL-PRS burst 225 may identify or otherwise determine the power control offset between the sidelink control block 220 scheduling the PSSCH and a first instance (e.g., first scheduled or added symbol) of the SL-PRS burst 225. The UE multiplexing its PSSCH with SL-PRS burst 225 may select a transmit power for the sidelink control block 220 and/or the first instance (e.g., the first symbol) of the SL-PRS burst 225 according to the power control offset. The UE receiving the multiplexed PSSCH and SL-PRS burst 225 may perform a power control procedure (e.g., an AGC procedure) for the sidelink control block 220 and/or the first instance of the SL-PRS burst 225 according to the power control offset.

Another example may include the average transmit power of all symbols within a slot being configured to be the same, whether the SL-PRS burst 225 is multiplexed or not. If the SL-PRS burst 225 has a larger bandwidth than the PSSCH, the per-resource element power of the SL-PRS burst 225 may be de-boosted in some examples. The UE multiplexing its PSSCH with its own SL-PRS burst 225 may select a common transmit power level for transmitting its PSSCH (which may include DMRS(s) associated with the PSSCH) and the SL-PRS burst 225. The UE receiving the multiplexed PSSCH and SL-PRS burst 225 may identify the common transmit power level and perform a power control procedure (e.g., an AGC retraining procedure) for the sidelink control block 220 and/or the first instance of the SL-PRS burst 225 based at least in part on the common transmit power level. That is, the receiver may maintain the same AGC state for the reception of the entire slot.

Another example may include the transmit power of the AGC symbol (e.g., the first symbol in the slot) being boosted to the maximum per-symbol average transmit power within the slot. That is, the UE multiplexing its PSSCH and SL-PRS burst 225 may identify the maximum transmit power level associated with the sidelink control block 220 and/or SL-PRS burst 225 and select a transmit power level for the sidelink control block 220 and/or SL-PRS burst 225 according to the maximum transmit power level. The UE receiving the multiplexed PSSCH and SL-PRS burst 225 may identify the maximum transmit power level and perform a power control procedure (e.g., AGC retuning procedure) for the sidelink control block and/or SL-PRS burst 225 according to the maximum transmit power level.

Some of the examples discussed above regarding power control/AGC may depend upon whether the receiving UE can maintain phase continuity regardless of the AGC state. In some of the examples, the SL-PRS burst 225 may be triggered by cross-slot scheduling or in a dedicated SL-PRS slot to provide sufficient SCI processing time.

Accordingly, a UE receiving a PSSCH multiplexed with a SL-PRS burst 225 may identify the burst pattern for the SL-PRS burst 225 to be transmitted by sidelink UE. The receiving UE may receive the PSSCH during the same time period that includes the SL-PRS burst 225. For example, the receiving UE may receive the PSSCH in the first resource elements that are different from the second resource elements that the SL-PRS burst 225 is scheduled in. The receiving UE may recover the PSSCH (e.g., when the UE is the addressee of the PSSCH). The receiving UE may determine its position based on the SL-PRS burst 225 (e.g., when the UE is performing positioning/location operations).

In the situation where the receiving UE receives the indication of the ZP-SL-PRS resources. The receiving UE may assume that the indicated rate matching or puncturing pattern for PSSCH demapping and decoding. The receiving UE may receive the sidelink control block 220 from the multiplexing UE that carries or otherwise indicated the ZP-SL-PRS (e.g., the ZP-reference signal (ZP-RS) pattern) indication that matches the second resource elements. The ZP-SL-PRS indication may provide an indication of the pattern for rate matching or puncturing used for reception of the PSSCH.

In the situation where the receiving UE does not receive an indication of the ZP-SL-PRS, the receiving UE may acquire the information relating to the multiplexed SL-PRS burst 225 and PSSCH before the PSSCH reception. The receiving UE may use the information to determine its rate matching or puncturing pattern for receiving the PSSCH. That is, the receiving UE may exchange message(s) that indicate the SL-PRS burst 225 pattern. The receiving UE may use the indication of the SL-PRS burst 225 pattern to identify or otherwise determine the rate matching or puncturing pattern used for receiving the PSSCH. The information may be acquired using network-wide signaling and/or peer-to-peer coordination between the multiplexing UE(s). The coordination may use SCI message(s), MAC CE, RRC message(s), broadcast messaging, multicast messaging, unicast messaging, cross-slot PRS triggering messaging, and the like. In some examples, the receiving UE may overhear the triggering SCI of SL-PRS burst 225 (e.g., may detect the reservation signal, such as the sidelink control block 220, scheduling the SL-PRS burst 225 and/or PSSCH).

In some situations, there may be a chance that the receiving UE may miss or otherwise fail to acquire the SL-PRS burst 225 information. In this scenario, puncturing may be preferred to rate matching. With puncturing, PSSCH may still be decodable (e.g., with some performance degradation) without knowing about the multiplexed SL-PRS burst 225. With rate matching, decoding PSSCH may be difficult without acquiring the multiplexed SL-PRS burst 225 information.

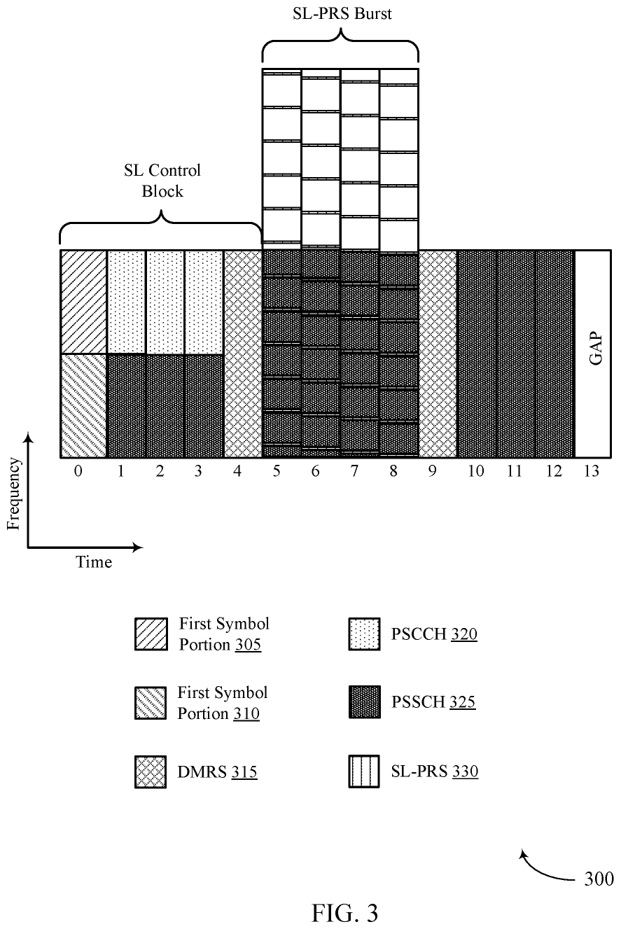

FIG. 3 illustrates an example of a PRS configuration 300 that supports multiplexing sidelink PRS and data in accordance with aspects of the present disclosure. PRS configuration 300 may implement aspects of wireless communication systems 100 and/or 200. Aspects of PRS configuration 300 may be implemented at or implemented by a UE, which may be an example of the corresponding devices described herein. Broadly, PRS configuration 300 illustrates an example where a UE multiplexes its PSSCH with its own SL-PRS burst.

As discussed above, aspects of the techniques described herein may provide for a UE to multiplex its PSSCH transmission (e.g., sidelink data message transmission) with a SL-PRS burst (e.g., its own SL-PRS burst or the SL-PRS burst(s) of other sidelink UE(s)). In the non-limiting example illustrated in FIG. 3, the UE may multiplex its PSSCH with its own SL-PRS burst. For example, the UE may identify or otherwise determine SL-PRS burst patterns identify bursts of SL-PRS to be transmitted by the UE (in this example). In this situation, this may include the UE scheduling the SL-PRS burst by transmitting a sidelink control block.

In some implementations, the slot format may be for (such as available for) sidelink communications in addition to other slot formats, but the slot format may be dedicated for SL-PRS transmissions in some examples. The slot format may include a first symbol portion 305 and a first symbol portion 310, one or more DMRSs 315, a PSCCH 320 (carrying SCI-1), a PSSCH 325 (e.g., carrying SCI-2 or other sidelink data), a SL-PRS burst including the SL-PRS 330, and one or more gap symbols. In some implementations, a first symbol portion 305 may be a repetition of a PSCCH 320, and a first symbol portion 310 may be a repetition of a DMRS 315 (for example, in a slot format associated with 14 total symbol duration). As shown in FIG. 3, the slot format may include an SL-PRS burst spanning four symbols, although a slot format with an SL-PRS burst spanning more symbols or fewer symbols may be adopted in some examples. In some implementations, the slot format may include PSSCH 325 (an SCI-2 and/or SL-SCH).

In some aspects, the UE may identify or otherwise determine the second resource elements that are scheduled for transmitting the SL-PRS 330. That is, the second resource elements may include the time, frequency, code, spatial, etc.) resources used for transmitting SL-PRS 330. In this situation where the UE is scheduling the SL-PRS burst, the UE may know the second resource elements.

Accordingly, the UE may schedule transmission of the PSSCH 325 (e.g., the sidelink data message) to occur during the same time period that includes the SL-PRS burst (e.g., during some or all of the symbols carrying the SL-PRS 330). The UE in this example may then transmit the PSSCH 325 via the first resource elements that are different from the second resource elements used to carry the SL-PRS 330 bursts.

Moreover, PRS configuration 300 illustrates an example where the UE uses a single sidelink control block to schedule the SL-PRS 330 and the PSSCH 325. That is, the UE may configure the sidelink control block to include one or more bits, fields, etc., associated with scheduling PSSCH 325 as well as one or more bits, fields, etc., associated with scheduling SL-PRS 330. In other examples, the UE may use separate sidelink control blocks (e.g., two sidelink control blocks) that separately schedule PSSCH 325 and SL-PRS 330.

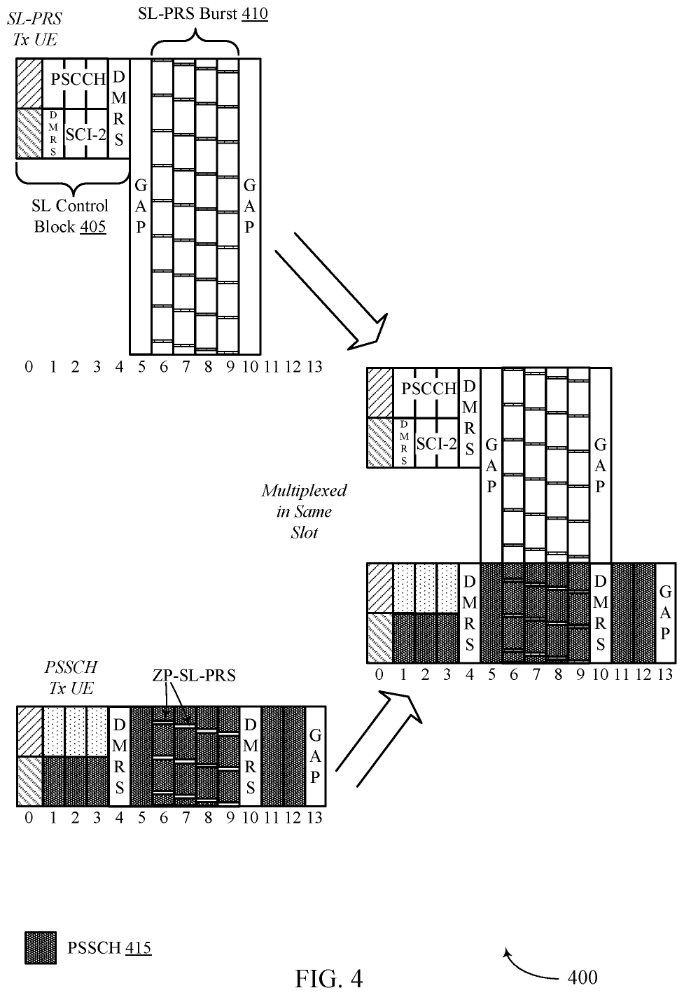

FIG. 4 illustrates an example of a PRS configuration 400 that supports multiplexing sidelink PRS and data in accordance with aspects of the present disclosure. PRS configuration 400 may implement aspects of wireless communication systems 100 and/or 200 and/or PRS configuration 300. Aspects of PRS configuration 400 may be implemented at or implemented by a UE, which may be an example of the corresponding devices described herein. Broadly, PRS configuration 400 illustrates an example where a UE multiplexes its PSSCH (e.g., the PSSCH Tx UE) with a SL-PRS burst transmitted by another sidelink UE (e.g., a SL-PRS Tx UE).

As discussed above, aspects of the techniques described herein may provide for a UE to multiplex its PSSCH transmission (e.g., sidelink data message transmission) with a SL-PRS burst (e.g., its own SL-PRS burst or the SL-PRS burst(s) of other sidelink UE(s)). In the non-limiting example illustrated in FIG. 4, the UE may multiplex its PSSCH with SL-PRS burst scheduled by other sidelink UE. For example, the UE may identify or otherwise determine SL-PRS burst patterns identifying bursts of SL-PRS to be transmitted by the other sidelink UE (in this example). In this situation, this may include the UE detecting sidelink control block 405 transmitted from the SL-PRS Tx UE scheduling the SL-PRS burst 410 transmission. In other examples, the UE may acquire the information pertaining to the SL-PRS burst 410 based on network-wide or peer-to-peer coordination, based on broadcast messaging, multicast messaging, unicast messaging, MAC CE messaging, RRC messaging, SCI messaging, and the like.

As discussed above, the slot format may be for (such as available for) sidelink communications in addition to other slot formats, but the slot format may be dedicated for SL-PRS transmissions in some examples. The slot format may include a first symbol portions, one or more DMRSs, a PSCCH (carrying SCI-1), a PSSCH 415 (e.g., carrying SCI-2 or other sidelink data message), a SL-PRS burst including the SL-PRS, and one or more gap symbols. In some implementations, a first symbol portion may be a repetition of a PSCCH, and another first symbol portion may be a repetition of a DMRS (for example, in a slot format associated with 14 total symbol duration). As shown in FIG. 4, the slot format may include an SL-PRS burst spanning four symbols, although a slot format with an SL-PRS burst spanning more symbols or fewer symbols may be adopted in some examples. In some implementations, the slot format may include PSSCH 415 (an SCI-2 and/or SL-SCH).

In some aspects, the UE may identify or otherwise determine the second resource elements that are scheduled for transmitting the SL-PRS burst 410. That is, the second resource elements may include the time, frequency, code, spatial, etc.) resources used for transmitting SL-PRS burst 410. In this situation where the UE is not scheduling the SL-PRS burst, the UE may know the second resource elements based on the messaging, coordination, etc.

Accordingly, the UE may schedule transmission of the PSSCH 415 (e.g., the sidelink data message) to occur during the same time period that includes the SL-PRS burst (e.g., during some or all of the symbols carrying the SL-PRS burst 410). The UE in this example may then transmit the PSSCH 415 via the first resource elements that are different from the second resource elements used to carry the SL-PRS burst 410.

In some examples, this may include the UE multiplexing its PSSCH 415 with the SL-PRS burst 410 transmitted from other sidelink UE transmitting an indication of a ZP-SL-PRS pattern that matches the second resource elements. That is, the UE may indicate the ZP-SL-PRS in its scheduling for PSSCH 415.

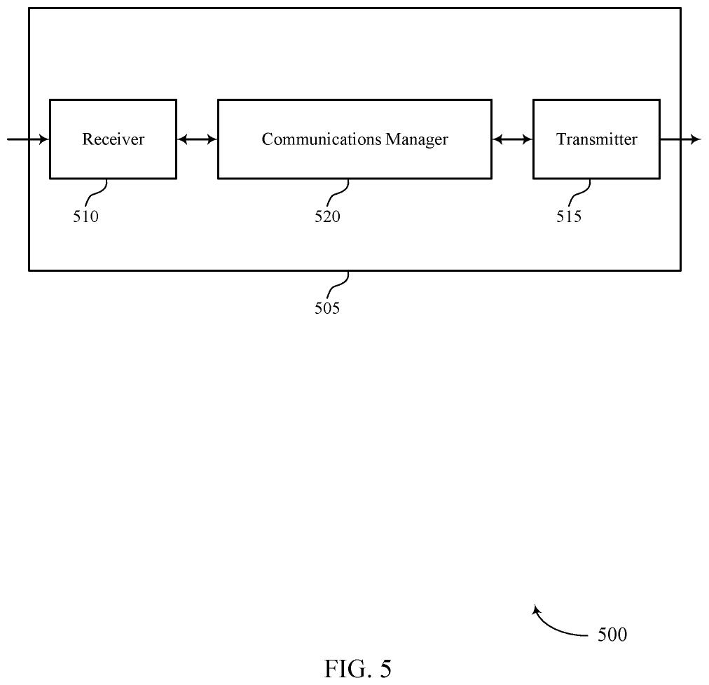

FIG. 5 shows a block diagram 500 of a device 505 that supports multiplexing sidelink PRS and data in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to multiplexing sidelink PRS and data). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to multiplexing sidelink PRS and data). In some examples, the transmitter 515 may be co-located with a receiver 510 in a transceiver. The transmitter 515 may utilize a single antenna or a set of multiple antennas.

The communications manager 520, the receiver 510, the transmitter 515, or various combinations thereof or various components thereof may be examples of means for performing various aspects of multiplexing sidelink PRS and data as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for identifying one or more sidelink PRS burst patterns identifying one or more bursts of sidelink PRS that are to be transmitted by either the UE or by other sidelink UEs. The communications manager 520 may be configured as or otherwise support a means for scheduling transmission of a sidelink data message to occurring during a same time period that includes the one or more bursts of sidelink PRS. The communications manager 520 may be configured as or otherwise support a means for transmitting the sidelink data message via first resource elements that are different from second resource elements on which the one or more bursts of sidelink PRS are transmitted.

Additionally, or alternatively, the communications manager 520 may support wireless communication at a first UE in accordance with examples as disclosed herein. For example, the communications manager 520 may be configured as or otherwise support a means for identifying one or more sidelink PRS burst patterns identifying one or more bursts of sidelink PRS to be transmitted by respective sidelink UEs. The communications manager 520 may be configured as or otherwise support a means for receiving, from a second UE, a sidelink data message during a same time period that includes the one or more bursts of sidelink PRS, the sidelink data message received via first resource elements that are different from second resource elements on which the one or more bursts of sidelink PRS are received. The communications manager 520 may be configured as or otherwise support a means for determining a position of the first UE based on receiving the one or more bursts of sidelink PRS.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for multiplexing PSSCH with SL-PRS bursts transmitted from the PSSCH UE and/or from other sidelink UEs.

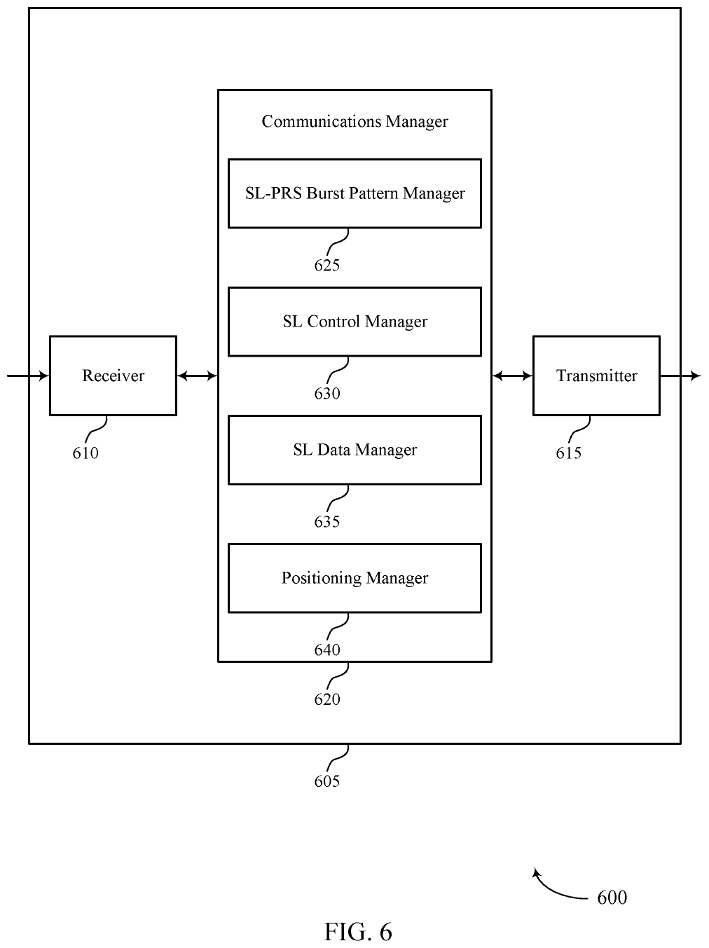

FIG. 6 shows a block diagram 600 of a device 605 that supports multiplexing sidelink PRS and data in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to multiplexing sidelink PRS and data). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to multiplexing sidelink PRS and data). In some examples, the transmitter 615 may be co-located with a receiver 610 in a transceiver. The transmitter 615 may utilize a single antenna or a set of multiple antennas.

The device 605, or various components thereof, may be an example of means for performing various aspects of multiplexing sidelink PRS and data as described herein. For example, the communications manager 620 may include an SL-PRS burst pattern manager 625, an SL control manager 630, an SL data manager 635, a positioning manager 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The SL-PRS burst pattern manager 625 may be configured as or otherwise support a means for identifying one or more sidelink PRS burst patterns identifying one or more bursts of sidelink PRS that are to be transmitted by either the UE or by other sidelink UEs. The SL control manager 630 may be configured as or otherwise support a means for scheduling transmission of a sidelink data message to occur during a same time period that includes the one or more bursts of sidelink PRS. The SL data manager 635 may be configured as or otherwise support a means for transmitting the sidelink data message via first resource elements that are different from second resource elements on which the one or more bursts of sidelink PRS are transmitted.

Additionally, or alternatively, the communications manager 620 may support wireless communication at a first UE in accordance with examples as disclosed herein. The SL-PRS burst pattern manager 625 may be configured as or otherwise support a means for identifying one or more sidelink PRS burst patterns identifying one or more bursts of sidelink PRS to be transmitted by respective sidelink UEs. The SL data manager 635 may be configured as or otherwise support a means for receiving, from a second UE, a sidelink data message during a same time period that includes the one or more bursts of sidelink PRS, the sidelink data message received via first resource elements that are different from second resource elements on which the one or more bursts of sidelink PRS are received. The positioning manager 640 may be configured as or otherwise support a means for determining a position of the first UE based on receiving the one or more bursts of sidelink PRS.

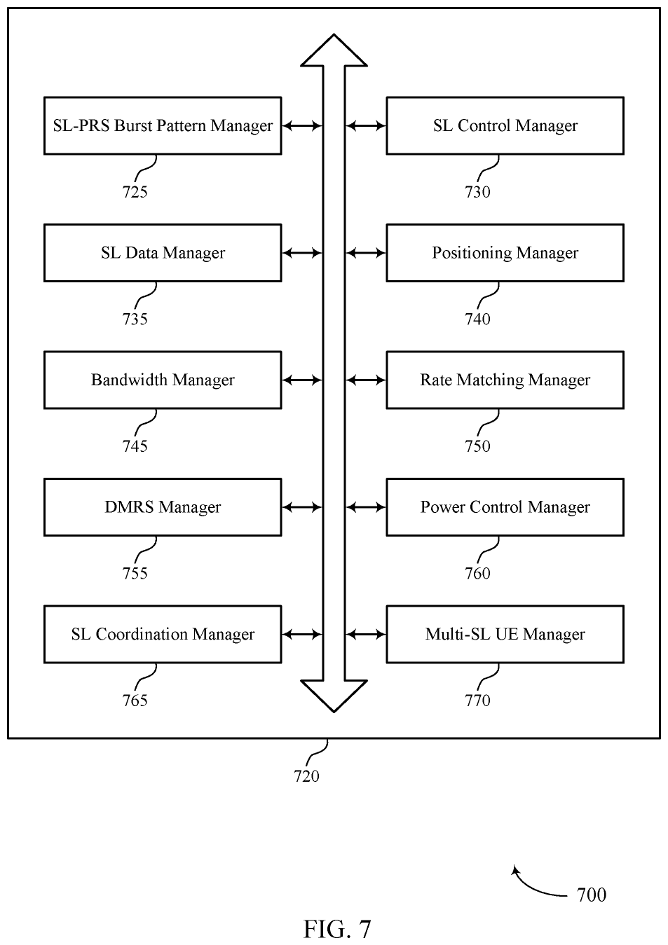

FIG. 7 shows a block diagram 700 of a communications manager 720 that supports multiplexing sidelink PRS and data in accordance with aspects of the present disclosure. The communications manager 720 may be an example of aspects of a communications manager 520, a communications manager 620, or both, as described herein. The communications manager 720, or various components thereof, may be an example of means for performing various aspects of multiplexing sidelink PRS and data as described herein. For example, the communications manager 720 may include an SL-PRS burst pattern manager 725, an SL control manager 730, an SL data manager 735, a positioning manager 740, a bandwidth manager 745, a rate matching manager 750, a DMRS manager 755, a power control manager 760, an SL coordination manager 765, a multi-SL UE manager 770, or any combination thereof. Each of these components may communicate, directly or indirectly, with one another (e.g., via one or more buses).

The communications manager 720 may support wireless communication at a UE in accordance with examples as disclosed herein. The SL-PRS burst pattern manager 725 may be configured as or otherwise support a means for identifying one or more sidelink PRS burst patterns identifying one or more bursts of sidelink PRS that are to be transmitted by either the UE or by other sidelink UEs. The SL control manager 730 may be configured as or otherwise support a means for scheduling transmission of a sidelink data message to occur during a same time period that includes the one or more bursts of sidelink PRS. The SL data manager 735 may be configured as or otherwise support a means for transmitting the sidelink data message via first resource elements that are different from second resource elements on which the one or more bursts of sidelink PRS are transmitted.

In some examples, to support scheduling the transmission of the sidelink data message, the bandwidth manager 745 may be configured as or otherwise support a means for identifying, for the transmission of the sidelink data message, the first resource elements as spanning a first bandwidth that is different from but at least partially overlaps with a second bandwidth spanned by the second resource elements.

In some examples, to support transmitting the sidelink data message, the rate matching manager 750 may be configured as or otherwise support a means for rate-matching the transmission of the sidelink data message around the second resource elements on which the one or more bursts of sidelink PRS are transmitted, where the UE also transmits a first set of multiple sidelink PRS of the one or more bursts of sidelink PRS in accordance with a first sidelink PRS burst pattern of the one or more sidelink PRS burst patterns.

In some examples, to support scheduling the transmission of the sidelink data message, the SL data manager 735 may be configured as or otherwise support a means for scheduling transmission of a sidelink shared channel message or a SCI stage two message, where the sidelink data message is scheduled to be transmitted as either a unicast, multicast, or broadcast message.

In some examples, the DMRS manager 755 may be configured as or otherwise support a means for transmitting one or more DMRSs associated with the sidelink data message multiplexed with the one or more bursts of sidelink PRS, where the multiplexing is at a resource element level or a code level.

In some examples, the DMRS manager 755 may be configured as or otherwise support a means for transmitting one or more DMRSs associated with the sidelink data message by puncturing, at a resource element level, a resource block level, a sub-channel level, or a symbol level, at least one of a portion of the one or more DMRSs, a subset of the one or more bursts of sidelink PRS, or both, in an overlapping frequency region associated with the sidelink data message.

In some examples, the DMRS manager 755 may be configured as or otherwise support a means for determining that one or more DMRSs associated with the sidelink data message are scheduled during one or more symbols associated with the first resource elements. In some examples, the DMRS manager 755 may be configured as or otherwise support a means for refraining from transmitting the one or more DMRSs based on the transmission of the sidelink data message being scheduled to occur during the one or more symbols, where the one or more symbols also include the one or more bursts of sidelink PRS. In some examples, a first symbol associated with the one or more bursts of sidelink PRS includes a power control symbol.

In some examples, the power control manager 760 may be configured as or otherwise support a means for identifying a power control offset between a sidelink control block scheduling the sidelink data message and a first instance of the one or more bursts of sidelink PRS. In some examples, the power control manager 760 may be configured as or otherwise support a means for selecting a transmit power level for the sidelink control block, the first instance of the one or more bursts of sidelink PRS, or both, based on the power control offset.

In some examples, the power control manager 760 may be configured as or otherwise support a means for selecting a common transmit power level for transmitting one or more DMRSs associated with the sidelink data message, the sidelink data message, and the one or more bursts of sidelink PRS. In some examples, the power control manager 760 may be configured as or otherwise support a means for identifying a maximum transmit power level associated with a sidelink control block scheduling the sidelink data message, the one or more bursts of sidelink PRS, or a combination thereof. In some examples, the power control manager 760 may be configured as or otherwise support a means for selecting a transmit power level for the sidelink control block, the sidelink data message, the one or more bursts of sidelink PRS, or a combination thereof, based on the maximum transmit power level.

In some examples, the SL control manager 730 may be configured as or otherwise support a means for transmitting a sidelink control block identifying a first sidelink PRS burst pattern that is to be transmitted by the UE, the sidelink control block further scheduling the sidelink data message that is to be transmitted by the UE.

In some examples, the SL control manager 730 may be configured as or otherwise support a means for transmitting a first sidelink control block identifying a first sidelink PRS burst pattern that is to be transmitted by the UE. In some examples, the SL control manager 730 may be configured as or otherwise support a means for transmitting a second sidelink control block scheduling the sidelink data message that is to be transmitted by the UE. In some examples, the one or more bursts of sidelink PRS include at least a first set of multiple sidelink PRS scheduled by a second UE in accordance with a first sidelink PRS burst pattern of the one or more sidelink PRS burst patterns. In some examples, the UE that transmits the sidelink data message is a first UE.

In some examples, the multi-SL UE manager 770 may be configured as or otherwise support a means for receiving information pertaining to the first sidelink PRS burst pattern via a network-wide or peer-to-peer coordination procedure between the first UE and the second UE.

In some examples, the multi-SL UE manager 770 may be configured as or otherwise support a means for performing the network-wide or peer-to-peer coordination procedure via one or more of an exchange of SCI messages, an exchange of MAC CE messages, an exchange of RRC messages, or a cross-slot PRS triggering procedure.

In some examples, to support transmitting the sidelink data message, the multi-SL UE manager 770 may be configured as or otherwise support a means for rate-matching the transmission of the sidelink data message around one or more of the second resource elements on which the first set of multiple sidelink PRS is transmitted. In some examples, to support transmitting the sidelink data message, the multi-SL UE manager 770 may be configured as or otherwise support a means for puncturing, by the transmission of the sidelink data message, one or more of the second resource elements on which the first set of multiple sidelink PRS is transmitted. In some examples, the second resource elements include a subset of guard resource elements that are not used for transmitting the first set of multiple sidelink PRS.

In some examples, the multi-SL UE manager 770 may be configured as or otherwise support a means for transmitting an indication to the second UE of a zero-power reference signal pattern that matches the second resource elements identified by the first sidelink PRS burst pattern, where the zero-power reference signal pattern is indicative of a rate-matching or puncturing pattern used for transmission of the sidelink data message. In some examples, the indication is an index included in a SCI message.

Additionally, or alternatively, the communications manager 720 may support wireless communication at a first UE in accordance with examples as disclosed herein. In some examples, the SL-PRS burst pattern manager 725 may be configured as or otherwise support a means for identifying one or more sidelink PRS burst patterns identifying one or more bursts of sidelink PRS to be transmitted by respective sidelink UEs. In some examples, the SL data manager 735 may be configured as or otherwise support a means for receiving, from a second UE, a sidelink data message during a same time period that includes the one or more bursts of sidelink PRS, the sidelink data message received via first resource elements that are different from second resource elements on which the one or more bursts of sidelink PRS are received. The positioning manager 740 may be configured as or otherwise support a means for determining a position of the first UE based on receiving the one or more bursts of sidelink PRS.

In some examples, to support identifying the one or more sidelink PRS burst patterns, the SL control manager 730 may be configured as or otherwise support a means for receiving, from the second UE, a sidelink control block indicating a zero-power reference signal pattern that matches the second resource elements, where the zero-power reference signal pattern is indicative of a rate-matching or puncturing pattern used for reception of the sidelink data message.

In some examples, to support identifying the one or more sidelink PRS burst patterns, the SL coordination manager 765 may be configured as or otherwise support a means for exchanging, from one or more of the respective sidelink UEs, one or more messages that indicate respective sidelink PRS burst patterns. In some examples, to support identifying the one or more sidelink PRS burst patterns, the SL coordination manager 765 may be configured as or otherwise support a means for identifying a rate-matching or puncturing pattern used for reception of the sidelink data message based on the one or more messages. In some examples, the one or more messages include a broadcast message, a multicast message, a unicast message, a SCI message, a MAC CE, an RRC message, a cross-slot PRS triggering procedure message, or a combination thereof.

In some examples, to support exchanging the one or more messages, the SL coordination manager 765 may be configured as or otherwise support a means for detecting a reservation signal from the one or more of the respective sidelink UEs indicating transmission of the one or more bursts of sidelink PRS according to the respective sidelink PRS burst pattern.

In some examples, to support receiving the sidelink data message, the rate matching manager 750 may be configured as or otherwise support a means for rate-matching the reception of the sidelink data message around the second resource elements on which the one or more bursts of sidelink PRS are received.

In some examples, the SL control manager 730 may be configured as or otherwise support a means for receiving, from a sidelink UE, a sidelink control block identifying a first sidelink PRS burst pattern that is to be transmitted by the sidelink UE, the sidelink control block further scheduling the sidelink data message that is to be transmitted by the sidelink UE. In some examples, the SL control manager 730 may be configured as or otherwise support a means for receiving, from a sidelink UE, a first sidelink control block identifying a first sidelink PRS burst pattern that is to be transmitted by the sidelink UE. In some examples, the SL control manager 730 may be configured as or otherwise support a means for receiving a second sidelink control block scheduling the sidelink data message that is to be transmitted by the sidelink UE.

In some examples, the DMRS manager 755 may be configured as or otherwise support a means for receiving one or more DMRSs associated with the sidelink data message multiplexed with the one or more bursts of sidelink PRS, where the multiplexing is at a resource element level or a code level.

In some examples, the DMRS manager 755 may be configured as or otherwise support a means for receiving one or more DMRSs associated with the sidelink data message that are punctured, at a resource element level, a resource block level, a sub-channel level, or a symbol level, with at least one of a portion of the one or more DMRSs, a subset of the one or more bursts of sidelink PRS, or both, in an overlapping frequency region associated with the sidelink data message.

In some examples, the DMRS manager 755 may be configured as or otherwise support a means for determining that one or more DMRSs associated with the sidelink data message are scheduled during one or more symbols associated with the first resource elements. In some examples, the DMRS manager 755 may be configured as or otherwise support a means for refraining from monitoring for the one or more DMRSs based on the reception of the sidelink data message being scheduled to occur during the one or more symbols, where the one or more symbols also include the one or more bursts of sidelink PRS. In some examples, a first symbol associated with the one or more bursts of sidelink PRS includes a power control symbol.

In some examples, the power control manager 760 may be configured as or otherwise support a means for identifying a power control offset between a sidelink control block scheduling the sidelink data message and a first instance of the one or more bursts of sidelink PRS. In some examples, the power control manager 760 may be configured as or otherwise support a means for performing a power control procedure for the sidelink control block, the first instance of the one or more bursts of sidelink PRS, or both, based on the power control offset.

In some examples, the power control manager 760 may be configured as or otherwise support a means for identifying a common transmit power level for receiving one or more DMRSs associated with the sidelink data message, the sidelink data message, and the one or more bursts of sidelink PRS. In some examples, the power control manager 760 may be configured as or otherwise support a means for performing a power control procedure for a sidelink control block, a first instance of the one or more bursts of sidelink PRS, or both, based on the common transmit power level.

In some examples, the power control manager 760 may be configured as or otherwise support a means for identifying a maximum transmit power level associated with a sidelink control block scheduling the sidelink data message, the one or more bursts of sidelink PRS, or a combination thereof. In some examples, the power control manager 760 may be configured as or otherwise support a means for performing a power control procedure for the sidelink control block, the sidelink data message, the one or more bursts of sidelink PRS, or a combination thereof, based on the maximum transmit power level.

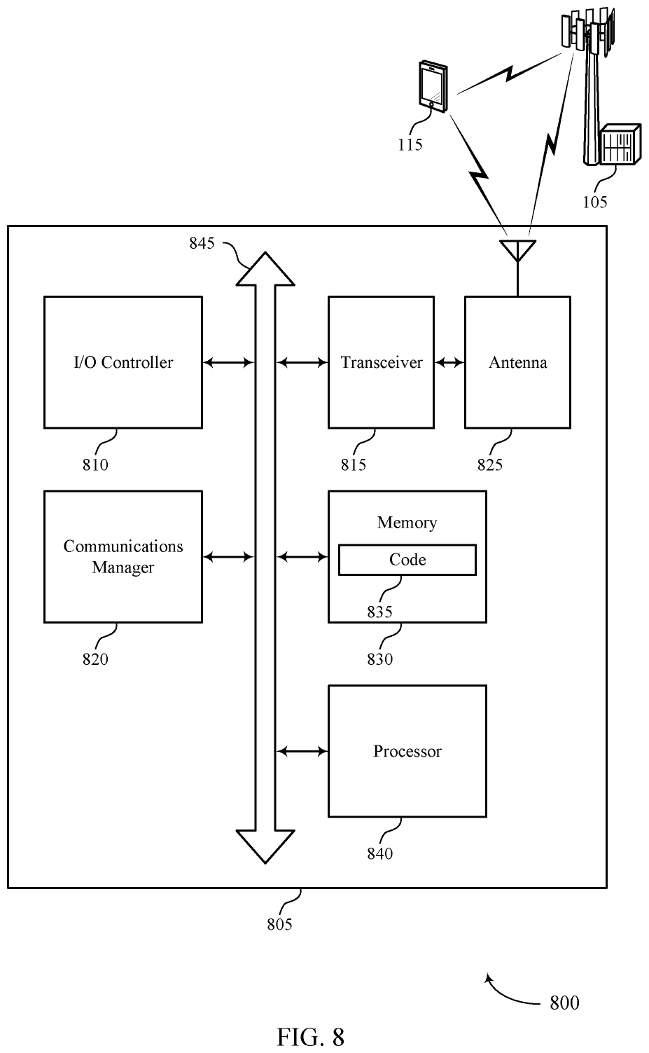

FIG. 8 shows a diagram of a system 800 including a device 805 that supports multiplexing sidelink PRS and data in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting multiplexing sidelink PRS and data). For example, the device 805 or a component of the device 805 may include a processor 840 and memory 830 coupled to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for identifying one or more sidelink PRS burst patterns identifying one or more bursts of sidelink PRS that are to be transmitted by either the UE or by other sidelink UEs. The communications manager 820 may be configured as or otherwise support a means for scheduling transmission of a sidelink data message to occurring during a same time period that includes the one or more bursts of sidelink PRS. The communications manager 820 may be configured as or otherwise support a means for transmitting the sidelink data message via first resource elements that are different from second resource elements on which the one or more bursts of sidelink PRS are transmitted.

Additionally, or alternatively, the communications manager 820 may support wireless communication at a first UE in accordance with examples as disclosed herein. For example, the communications manager 820 may be configured as or otherwise support a means for identifying one or more sidelink PRS burst patterns identifying one or more bursts of sidelink PRS to be transmitted by respective sidelink UEs. The communications manager 820 may be configured as or otherwise support a means for receiving, from a second UE, a sidelink data message during a same time period that includes the one or more bursts of sidelink PRS, the sidelink data message received via first resource elements that are different from second resource elements on which the one or more bursts of sidelink PRS are received. The communications manager 820 may be configured as or otherwise support a means for determining a position of the first UE based on receiving the one or more bursts of sidelink PRS.

By including or configuring the communications manager 820 in accordance with examples as described herein, the device 805 may support techniques for multiplexing PSSCH with SL-PRS bursts transmitted from the PSSCH UE and/or from other sidelink UEs.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of multiplexing sidelink PRS and data as described herein, or the processor 840 and the memory 830 may be otherwise configured to perform or support such operations.

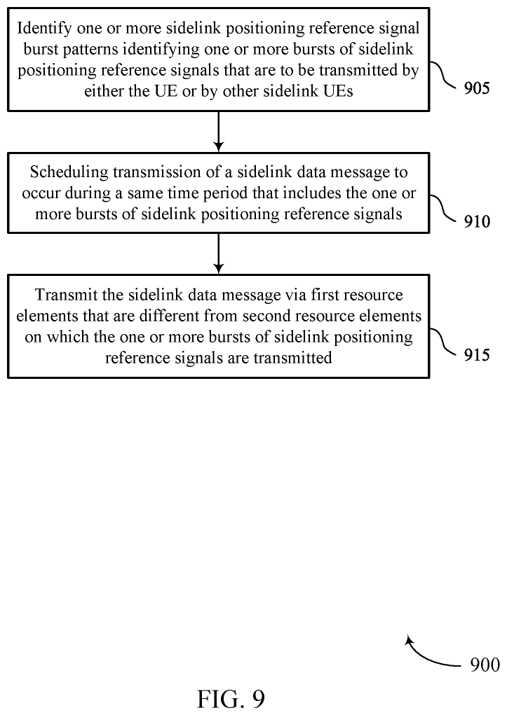

FIG. 9 shows a flowchart illustrating a method 900 that supports multiplexing sidelink PRS and data in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include identifying one or more sidelink PRS burst patterns identifying one or more bursts of sidelink PRS that are to be transmitted by either the UE or by other sidelink UEs. The operations of 905 may be performed in accordance with examples as disclosed herein. In some examples, aspects of the operations of 905 may be performed by an SL-PRS burst pattern manager 725 as described with reference to FIG. 7.

At 910, the method may include scheduling transmission of a sidelink data message to occur during a same time period that includes the one or more bursts of sidelink PRS. The operations of 910 may be performed in accordance with examples as disclosed herein. In some examples, aspects of the operations of 910 may be performed by an SL control manager 730 as described with reference to FIG. 7.

At 915, the method may include transmitting the sidelink data message via first resource elements that are different from second resource elements on which the one or more bursts of sidelink PRS are transmitted. The operations of 915 may be performed in accordance with examples as disclosed herein. In some examples, aspects of the operations of 915 may be performed by an SL data manager 735 as described with reference to FIG. 7.

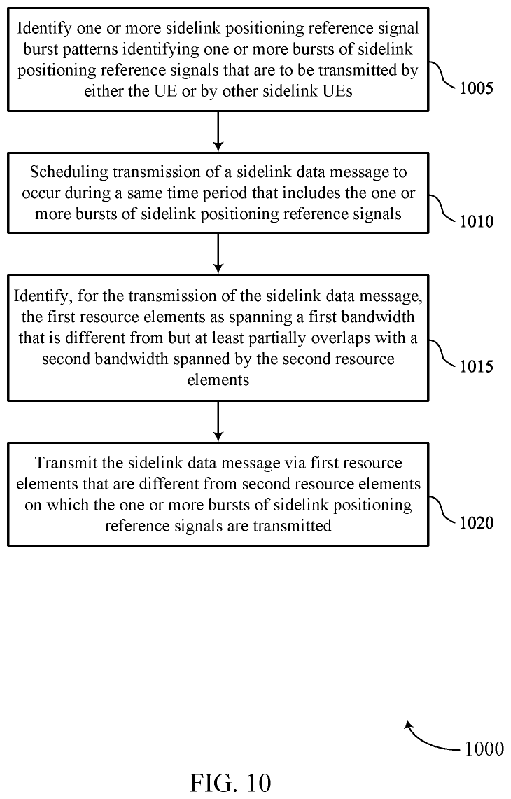

FIG. 10 shows a flowchart illustrating a method 1000 that supports multiplexing sidelink PRS and data in accordance with aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include identifying one or more sidelink PRS burst patterns identifying one or more bursts of sidelink PRS that are to be transmitted by either the UE or by other sidelink UEs. The operations of 1005 may be performed in accordance with examples as disclosed herein. In some examples, aspects of the operations of 1005 may be performed by an SL-PRS burst pattern manager 725 as described with reference to FIG. 7.

At 1010, the method may include scheduling transmission of a sidelink data message to occur during a same time period that includes the one or more bursts of sidelink PRS. The operations of 1010 may be performed in accordance with examples as disclosed herein. In some examples, aspects of the operations of 1010 may be performed by an SL control manager 730 as described with reference to FIG. 7.

At 1015, the method may include identifying, for the transmission of the sidelink data message, the first resource elements as spanning a first bandwidth that is different from but at least partially overlaps with a second bandwidth spanned by the second resource elements. The operations of 1015 may be performed in accordance with examples as disclosed herein. In some examples, aspects of the operations of 1015 may be performed by a bandwidth manager 745 as described with reference to FIG. 7.

At 1020, the method may include transmitting the sidelink data message via first resource elements that are different from second resource elements on which the one or more bursts of sidelink PRS are transmitted. The operations of 1020 may be performed in accordance with examples as disclosed herein. In some examples, aspects of the operations of 1020 may be performed by an SL data manager 735 as described with reference to FIG. 7.

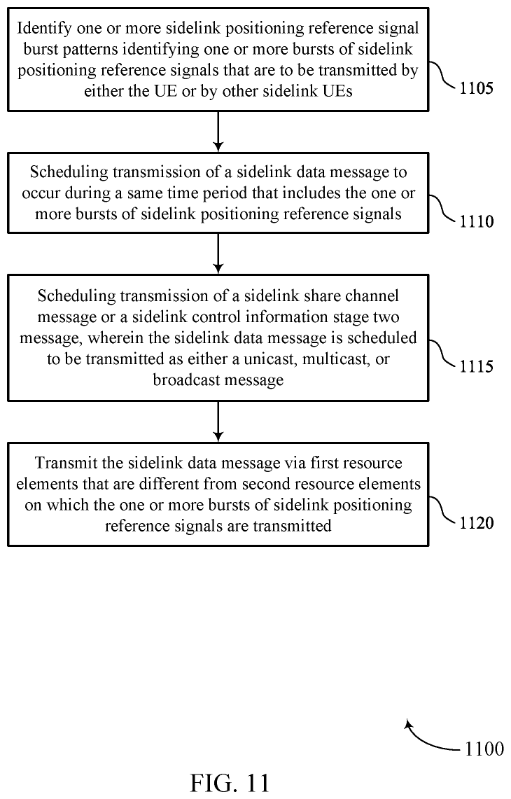

FIG. 11 shows a flowchart illustrating a method 1100 that supports multiplexing sidelink PRS and data in accordance with aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include identifying one or more sidelink PRS burst patterns identifying one or more bursts of sidelink PRS that are to be transmitted by either the UE or by other sidelink UEs. The operations of 1105 may be performed in accordance with examples as disclosed herein. In some examples, aspects of the operations of 1105 may be performed by an SL-PRS burst pattern manager 725 as described with reference to FIG. 7.

At 1110, the method may include scheduling transmission of a sidelink data message to occur during a same time period that includes the one or more bursts of sidelink PRS. The operations of 1110 may be performed in accordance with examples as disclosed herein. In some examples, aspects of the operations of 1110 may be performed by an SL control manager 730 as described with reference to FIG. 7.

At 1115, the method may include scheduling transmission of a sidelink shared channel message or a SCI stage two message, where the sidelink data message is scheduled to be transmitted as either a unicast, multicast, or broadcast message. The operations of 1115 may be performed in accordance with examples as disclosed herein. In some examples, aspects of the operations of 1115 may be performed by an SL data manager 735 as described with reference to FIG. 7.

At 1120, the method may include transmitting the sidelink data message via first resource elements that are different from second resource elements on which the one or more bursts of sidelink PRS are transmitted. The operations of 1120 may be performed in accordance with examples as disclosed herein. In some examples, aspects of the operations of 1120 may be performed by an SL data manager 735 as described with reference to FIG. 7.

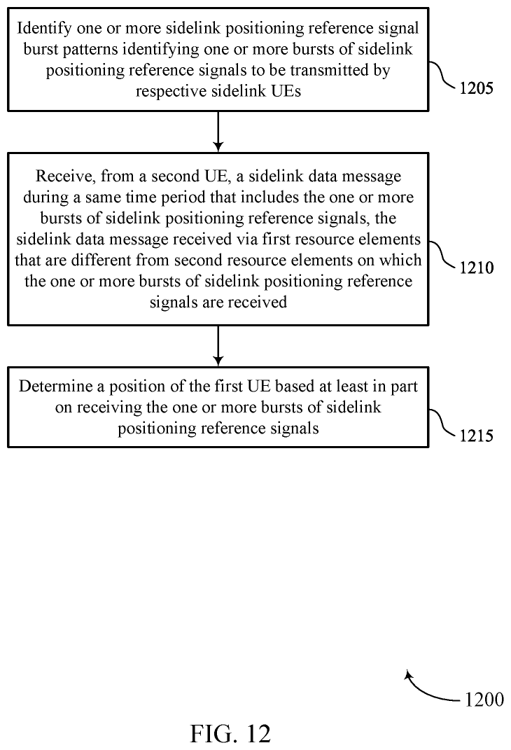

FIG. 12 shows a flowchart illustrating a method 1200 that supports multiplexing sidelink PRS and data in accordance with aspects of the present disclosure. The operations of the method 1200 may be implemented by a UE or its components as described herein. For example, the operations of the method 1200 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1205, the method may include identifying one or more sidelink PRS burst patterns identifying one or more bursts of sidelink PRS to be transmitted by respective sidelink UEs. The operations of 1205 may be performed in accordance with examples as disclosed herein. In some examples, aspects of the operations of 1205 may be performed by an SL-PRS burst pattern manager 725 as described with reference to FIG. 7.

At 1210, the method may include receiving, from a second UE, a sidelink data message during a same time period that includes the one or more bursts of sidelink PRS, the sidelink data message received via first resource elements that are different from second resource elements on which the one or more bursts of sidelink PRS are received. The operations of 1210 may be performed in accordance with examples as disclosed herein. In some examples, aspects of the operations of 1210 may be performed by an SL data manager 735 as described with reference to FIG. 7.

At 1215, the method may include determining a position of the first UE based on receiving the one or more bursts of sidelink PRS. The operations of 1215 may be performed in accordance with examples as disclosed herein. In some examples, aspects of the operations of 1215 may be performed by a positioning manager 740 as described with reference to FIG. 7.

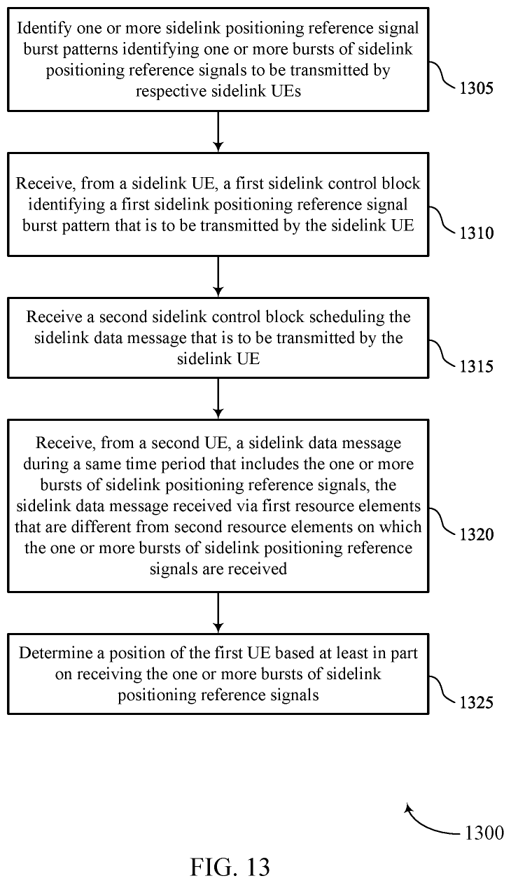

FIG. 13 shows a flowchart illustrating a method 1300 that supports multiplexing sidelink PRS and data in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include identifying one or more sidelink PRS burst patterns identifying one or more bursts of sidelink PRS to be transmitted by respective sidelink UEs. The operations of 1305 may be performed in accordance with examples as disclosed herein. In some examples, aspects of the operations of 1305 may be performed by an SL-PRS burst pattern manager 725 as described with reference to FIG. 7.

At 1310, the method may include receiving, from a sidelink UE, a first sidelink control block identifying a first sidelink PRS burst pattern that is to be transmitted by the sidelink UE. The operations of 1310 may be performed in accordance with examples as disclosed herein. In some examples, aspects of the operations of 1310 may be performed by an SL control manager 730 as described with reference to FIG. 7.

At 1315, the method may include receiving a second sidelink control block scheduling the sidelink data message that is to be transmitted by the sidelink UE. The operations of 1315 may be performed in accordance with examples as disclosed herein. In some examples, aspects of the operations of 1315 may be performed by an SL control manager 730 as described with reference to FIG. 7.

At 1320, the method may include receiving, from a second UE, a sidelink data message during a same time period that includes the one or more bursts of sidelink PRS, the sidelink data message received via first resource elements that are different from second resource elements on which the one or more bursts of sidelink PRS are received. The operations of 1320 may be performed in accordance with examples as disclosed herein. In some examples, aspects of the operations of 1320 may be performed by an SL data manager 735 as described with reference to FIG. 7.

At 1325, the method may include determining a position of the first UE based on receiving the one or more bursts of sidelink PRS. The operations of 1325 may be performed in accordance with examples as disclosed herein. In some examples, aspects of the operations of 1325 may be performed by a positioning manager 740 as described with reference to FIG. 7.

The following provides an overview of aspects of the present disclosure:

Aspect 1: A method for wireless communication at a UE, comprising: identifying one or more sidelink PRS burst patterns identifying one or more bursts of sidelink PRSs that are to be transmitted by either the UE or by other sidelink UEs; scheduling transmission of a sidelink data message to occur during a same time period that includes the one or more bursts of sidelink PRSs; and transmitting the sidelink data message via first resource elements that are different from second resource elements on which the one or more bursts of sidelink PRSs are transmitted.

Aspect 2: The method of aspect 1, wherein scheduling the transmission of the sidelink data message further comprises: identifying, for the transmission of the sidelink data message, the first resource elements as spanning a first bandwidth that is different from but at least partially overlaps with a second bandwidth spanned by the second resource elements.

Aspect 3: The method of any of aspects 1 through 2, wherein transmitting the sidelink data message further comprises: rate-matching the transmission of the sidelink data message around the second resource elements on which the one or more bursts of sidelink PRSs are transmitted, wherein the UE also transmits a first plurality of sidelink PRSs of the one or more bursts of sidelink PRSs in accordance with a first sidelink PRS burst pattern of the one or more sidelink PRS burst patterns.

Aspect 4: The method of any of aspects 1 through 3, wherein scheduling the transmission of the sidelink data message further comprises: scheduling transmission of a sidelink shared channel message or a SCI stage two message, wherein the sidelink data message is scheduled to be transmitted as either a unicast, multicast, or broadcast message.

Aspect 5: The method of any of aspects 1 through 4, further comprising: transmitting one or more DMRSs associated with the sidelink data message multiplexed with the one or more bursts of sidelink PRSs, wherein the multiplexing is at a resource element level or a code level.

Aspect 6: The method of any of aspects 1 through 5, further comprising: transmitting one or more DMRSs associated with the sidelink data message by puncturing, at a resource element level, a resource block level, a sub-channel level, or a symbol level, at least one of a portion of the one or more DMRSs, a subset of the one or more bursts of sidelink PRSs, or both, in an overlapping frequency region associated with the sidelink data message.

Aspect 7: The method of any of aspects 1 through 6, further comprising: determining that one or more DMRSs associated with the sidelink data message are scheduled during one or more symbols associated with the first resource elements; and refraining from transmitting the one or more DMRSs based at least in part on the transmission of the sidelink data message being scheduled to occur during the one or more symbols, wherein the one or more symbols also include the one or more bursts of sidelink PRSs.

Aspect 8: The method of any of aspects 1 through 7, wherein a first symbol associated with the one or more bursts of sidelink PRSs comprises a power control symbol.

Aspect 9: The method of any of aspects 1 through 8, further comprising: identifying a power control offset between a sidelink control block scheduling the sidelink data message and a first instance of the one or more bursts of sidelink PRSs; and selecting a transmit power level for the sidelink control block, the first instance of the one or more bursts of sidelink PRSs, or both, based at least in part on the power control offset.

Aspect 10: The method of any of aspects 1 through 9, further comprising: selecting a common transmit power level for transmitting one or more DMRSs associated with the sidelink data message, the sidelink data message, and the one or more bursts of sidelink PRSs.

Aspect 11: The method of any of aspects 1 through 10, further comprising: identifying a maximum transmit power level associated with a sidelink control block scheduling the sidelink data message, the one or more bursts of sidelink PRSs, or a combination thereof; and selecting a transmit power level for the sidelink control block, the sidelink data message, the one or more bursts of sidelink PRSs, or a combination thereof, based at least in part on the maximum transmit power level.

Aspect 12: The method of any of aspects 1 through 11, further comprising: transmitting a sidelink control block identifying a first sidelink PRS burst pattern that is to be transmitted by the UE, the sidelink control block further scheduling the sidelink data message that is to be transmitted by the UE.

Aspect 13: The method of any of aspects 1 through 12, further comprising: transmitting a first sidelink control block identifying a first sidelink PRS burst pattern that is to be transmitted by the UE; and transmitting a second sidelink control block scheduling the sidelink data message that is to be transmitted by the UE.

Aspect 14: The method of any of aspects 1 through 13, wherein the one or more bursts of sidelink PRSs include at least a first plurality of sidelink PRSs scheduled by a second UE in accordance with a first sidelink PRS burst pattern of the one or more sidelink PRS burst patterns; and the UE that transmits the sidelink data message is a first UE.

Aspect 15: The method of aspect 14, further comprising: receiving information pertaining to the first sidelink PRS burst pattern via a network-wide or peer-to-peer coordination procedure between the first UE and the second UE.

Aspect 16: The method of aspect 15, further comprising: performing the network-wide or peer-to-peer coordination procedure via one or more of an exchange of SCI messages, an exchange of MAC CE messages, an exchange of RRC messages, or a cross-slot PRS triggering procedure.

Aspect 17: The method of any of aspects 14 through 16, wherein transmitting the sidelink data message further comprises: rate-matching the transmission of the sidelink data message around one or more of the second resource elements on which the first plurality of sidelink PRSs is transmitted.

Aspect 18: The method of any of aspects 14 through 17, wherein transmitting the sidelink data message further comprises: puncturing, by the transmission of the sidelink data message, one or more of the second resource elements on which the first plurality of sidelink PRSs is transmitted.

Aspect 19: The method of any of aspects 14 through 18, wherein the second resource elements include a subset of guard resource elements that are not used for transmitting the first plurality of sidelink PRSs.

Aspect 20: The method of any of aspects 14 through 19, further comprising: transmitting an indication to the second UE of a zero-power reference signal pattern that matches the second resource elements identified by the first sidelink PRS burst pattern, wherein the zero-power reference signal pattern is indicative of a rate-matching or puncturing pattern used for transmission of the sidelink data message.

Aspect 21: The method of aspect 20, wherein the indication is an index included in a SCI message.

Aspect 22: A method for wireless communication at a first UE, comprising: identifying one or more sidelink PRS burst patterns identifying one or more bursts of sidelink PRSs to be transmitted by respective sidelink UEs; receiving, from a second UE, a sidelink data message during a same time period that includes the one or more bursts of sidelink PRSs, the sidelink data message received via first resource elements that are different from second resource elements on which the one or more bursts of sidelink PRSs are received; and determining a position of the first UE based at least in part on receiving the one or more bursts of sidelink PRSs.

Aspect 23: The method of aspect 22, wherein identifying the one or more sidelink PRS burst patterns comprises: receiving, from the second UE, a sidelink control block indicating a zero-power reference signal pattern that matches the second resource elements, wherein the zero-power reference signal pattern is indicative of a rate-matching or puncturing pattern used for reception of the sidelink data message.

Aspect 24: The method of any of aspects 22 through 23, wherein identifying the one or more sidelink PRS burst patterns comprises: exchanging, from one or more of the respective sidelink UEs, one or more messages that indicate respective sidelink PRS burst patterns; and identifying a rate-matching or puncturing pattern used for reception of the sidelink data message based at least in part on the one or more messages.

Aspect 25: The method of aspect 24, wherein the one or more messages comprise a broadcast message, a multicast message, a unicast message, a SCI message, a MAC CE, an RRC message, a cross-slot PRS triggering procedure message, or a combination thereof.

Aspect 26: The method of any of aspects 24 through 25, wherein exchanging the one or more messages comprises: detecting a reservation signal from the one or more of the respective sidelink UEs indicating transmission of the one or more bursts of sidelink PRSs according to the respective sidelink PRS burst pattern.

Aspect 27: The method of any of aspects 22 through 26, wherein receiving the sidelink data message further comprises: rate-matching the reception of the sidelink data message around the second resource elements on which the one or more bursts of sidelink PRSs are received.

Aspect 28: The method of any of aspects 22 through 27, further comprising: receiving, from a sidelink UE, a sidelink control block identifying a first sidelink PRS burst pattern that is to be transmitted by the sidelink UE, the sidelink control block further scheduling the sidelink data message that is to be transmitted by the sidelink UE.

Aspect 29: The method of any of aspects 22 through 28, further comprising: receiving, from a sidelink UE, a first sidelink control block identifying a first sidelink PRS burst pattern that is to be transmitted by the sidelink UE; and receiving a second sidelink control block scheduling the sidelink data message that is to be transmitted by the sidelink UE.

Aspect 30: The method of any of aspects 22 through 29, further comprising: receiving one or more DMRSs associated with the sidelink data message multiplexed with the one or more bursts of sidelink PRSs, wherein the multiplexing is at a resource element level or a code level.

Aspect 31: The method of any of aspects 22 through 30, further comprising: receiving one or more DMRSs associated with the sidelink data message that are punctured, at a resource element level, a resource block level, a sub-channel level, or a symbol level, with at least one of a portion of the one or more DMRSs, a subset of the one or more bursts of sidelink PRSs, or both, in an overlapping frequency region associated with the sidelink data message.

Aspect 32: The method of any of aspects 22 through 31, further comprising: determining that one or more DMRSs associated with the sidelink data message are scheduled during one or more symbols associated with the first resource elements; and refraining from monitoring for the one or more DMRSs based at least in part on the reception of the sidelink data message being scheduled to occur during the one or more symbols, wherein the one or more symbols also include the one or more bursts of sidelink PRSs.

Aspect 33: The method of any of aspects 22 through 32, wherein a first symbol associated with the one or more bursts of sidelink PRSs comprises a power control symbol.

Aspect 34: The method of any of aspects 22 through 33, further comprising: identifying a power control offset between a sidelink control block scheduling the sidelink data message and a first instance of the one or more bursts of sidelink PRSs; and performing a power control procedure for the sidelink control block, the first instance of the one or more bursts of sidelink PRSs, or both, based at least in part on the power control offset.

Aspect 35: The method of any of aspects 22 through 34, further comprising: identifying a common transmit power level for receiving one or more DMRSs associated with the sidelink data message, the sidelink data message, and the one or more bursts of sidelink PRSs; and performing a power control procedure for a sidelink control block, a first instance of the one or more bursts of sidelink PRSs, or both, based at least in part on the common transmit power level.

Aspect 36: The method of any of aspects 22 through 35, further comprising: identifying a maximum transmit power level associated with a sidelink control block scheduling the sidelink data message, the one or more bursts of sidelink PRSs, or a combination thereof; and performing a power control procedure for the sidelink control block, the sidelink data message, the one or more bursts of sidelink PRSs, or a combination thereof, based at least in part on the maximum transmit power level.

Aspect 37: An apparatus for wireless communication at a UE, comprising a processor; memory coupled with the processor; and instructions stored in the memory and executable by the processor to cause the apparatus to perform a method of any of aspects 1 through 21.

Aspect 38: An apparatus for wireless communication at a UE, comprising at least one means for performing a method of any of aspects 1 through 21.

Aspect 39: A non-transitory computer-readable medium storing code for wireless communication at a UE, the code comprising instructions executable by a processor to perform a method of any of aspects 1 through 21.

Aspect 40: An apparatus for wireless communication at a first UE, comprising a processor; memory coupled with the processor; and instructions stored in the memory and executable by the processor to cause the apparatus to perform a method of any of aspects 22 through 36.

Aspect 41: An apparatus for wireless communication at a first UE, comprising at least one means for performing a method of any of aspects 22 through 36.

Aspect 42: A non-transitory computer-readable medium storing code for wireless communication at a first UE, the code comprising instructions executable by a processor to perform a method of any of aspects 22 through 36.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
identifying one or more sidelink positioning reference signal burst patterns identifying one or more bursts of sidelink positioning reference signals that are to be transmitted by either the UE or by other sidelink UEs;
scheduling transmission of a sidelink data message to occur during a same time period that includes the one or more bursts of sidelink positioning reference signals; and
transmitting the sidelink data message via first resource elements that are different from second resource elements on which the one or more bursts of sidelink positioning reference signals are transmitted.

2. The method of claim 1, wherein scheduling the transmission of the sidelink data message further comprises:
identifying, for the transmission of the sidelink data message, the first resource elements as spanning a first bandwidth that is different from but at least partially overlaps with a second bandwidth spanned by the second resource elements.

3. The method of claim 1, wherein transmitting the sidelink data message further comprises:
rate-matching the transmission of the sidelink data message around the second resource elements on which the one or more bursts of sidelink positioning reference signals are transmitted, wherein the UE also transmits a first plurality of sidelink positioning reference signals of the one or more bursts of sidelink positioning reference signals in accordance with a first sidelink positioning reference signal burst pattern of the one or more sidelink positioning reference signal burst patterns.

4. The method of claim 1, wherein scheduling the transmission of the sidelink data message further comprises:
scheduling transmission of a sidelink shared channel message or a sidelink control information stage two message, wherein the sidelink data message is scheduled to be transmitted as either a unicast, multicast, or broadcast message.

5. The method of claim 1, further comprising:
transmitting one or more demodulation reference signals associated with the sidelink data message multiplexed with the one or more bursts of sidelink positioning reference signals, wherein the multiplexing is at a resource element level or a code level.

6. The method of claim 1, further comprising:
transmitting one or more demodulation reference signals associated with the sidelink data message by puncturing, at a resource element level, a resource block level, a sub-channel level, or a symbol level, at least one of a portion of the one or more demodulation reference signals, a subset of the one or more bursts of sidelink positioning reference signals, or both, in an overlapping frequency region associated with the sidelink data message.

7. The method of claim 1, further comprising:
determining that one or more demodulation reference signals associated with the sidelink data message are scheduled during one or more symbols associated with the first resource elements; and
refraining from transmitting the one or more demodulation reference signals based at least in part on the transmission of the sidelink data message being scheduled to occur during the one or more symbols, wherein the one or more symbols also include the one or more bursts of sidelink positioning reference signals.

8. The method of claim 1, wherein a first symbol associated with the one or more bursts of sidelink positioning reference signals comprises a power control symbol.

9. The method of claim 1, further comprising:
identifying a power control offset between a sidelink control block scheduling the sidelink data message and a first instance of the one or more bursts of sidelink positioning reference signals; and
selecting a transmit power level for the sidelink control block, the first instance of the one or more bursts of sidelink positioning reference signals, or both, based at least in part on the power control offset.

10. The method of claim 1, further comprising:
selecting a common transmit power level for transmitting one or more demodulation reference signals associated with the sidelink data message, the sidelink data message, and the one or more bursts of sidelink positioning reference signals.

11. The method of claim 1, further comprising:
identifying a maximum transmit power level associated with a sidelink control block scheduling the sidelink data message, the one or more bursts of sidelink positioning reference signals, or a combination thereof; and
selecting a transmit power level for the sidelink control block, the sidelink data message, the one or more bursts of sidelink positioning reference signals, or a combination thereof, based at least in part on the maximum transmit power level.

12. The method of claim 1, further comprising:
transmitting a sidelink control block identifying a first sidelink positioning reference signal burst pattern that is to be transmitted by the UE, the sidelink control block further scheduling the sidelink data message that is to be transmitted by the UE.

13. The method of claim 1, further comprising:
transmitting a first sidelink control block identifying a first sidelink positioning reference signal burst pattern that is to be transmitted by the UE; and
transmitting a second sidelink control block scheduling the sidelink data message that is to be transmitted by the UE.

14. The method of claim 1, wherein
the one or more bursts of sidelink positioning reference signals include at least a first plurality of sidelink positioning reference signals scheduled by a second UE in accordance with a first sidelink positioning reference signal burst pattern of the one or more sidelink positioning reference signal burst patterns,
the UE that transmits the sidelink data message is a first UE.

15. The method of claim 14, further comprising:
receiving information pertaining to the first sidelink positioning reference signal burst pattern via a network-wide or peer-to-peer coordination procedure between the first UE and the second UE.

16. The method of claim 15, further comprising:
performing the network-wide or peer-to-peer coordination procedure via one or more of an exchange of sidelink control information messages, an exchange of medium access control (MAC) control element (CE) messages, an exchange of radio resource control messages, or a cross-slot positioning reference signal triggering procedure.

17. The method of claim 14, wherein transmitting the sidelink data message further comprises:
rate-matching the transmission of the sidelink data message around one or more of the second resource elements on which the first plurality of sidelink positioning reference signals is transmitted.

18. The method of claim 14, wherein transmitting the sidelink data message further comprises:
puncturing, by the transmission of the sidelink data message, one or more of the second resource elements on which the first plurality of sidelink positioning reference signals is transmitted.

19. The method of claim 14, wherein the second resource elements include a subset of guard resource elements that are not used for transmitting the first plurality of sidelink positioning reference signals.

20. The method of claim 14, further comprising:
transmitting an indication to the second UE of a zero-power reference signal pattern that matches the second resource elements identified by the first sidelink positioning reference signal burst pattern, wherein the zero-power reference signal pattern is indicative of a rate-matching or puncturing pattern used for transmission of the sidelink data message.

21. The method of claim 20, wherein the indication is an index included in a sidelink control information message.

22. A method for wireless communication at a first user equipment (UE), comprising:
identifying one or more sidelink positioning reference signal burst patterns identifying one or more bursts of sidelink positioning reference signals to be transmitted by respective sidelink UEs;
receiving, from a second UE, a sidelink data message during a same time period that includes the one or more bursts of sidelink positioning reference signals, the sidelink data message received via first resource elements that are different from second resource elements on which the one or more bursts of sidelink positioning reference signals are received; and
determining a position of the first UE based at least in part on receiving the one or more bursts of sidelink positioning reference signals.

23. The method of claim 22, wherein identifying the one or more sidelink positioning reference signal burst patterns comprises:
receiving, from the second UE, a sidelink control block indicating a zero-power reference signal pattern that matches the second resource elements, wherein the zero-power reference signal pattern is indicative of a rate-matching or puncturing pattern used for reception of the sidelink data message.

24. The method of claim 22, wherein identifying the one or more sidelink positioning reference signal burst patterns comprises:
exchanging, from one or more of the respective sidelink UEs, one or more messages that indicate respective sidelink positioning reference signal burst patterns; and
identifying a rate-matching or puncturing pattern used for reception of the sidelink data message based at least in part on the one or more messages.

25. The method of claim 24, wherein the one or more messages comprise a broadcast message, a multicast message, a unicast message, a sidelink control information (SCI) message, a medium access control (MAC) control element (CE), a radio resource control (RRC) message, a cross-slot positioning reference signal triggering procedure message, or a combination thereof.

26. The method of claim 24, wherein exchanging the one or more messages comprises:
detecting a reservation signal from the one or more of the respective sidelink UEs indicating transmission of the one or more bursts of sidelink positioning reference signals according to the respective sidelink positioning reference signal burst pattern.

27. The method of claim 22, wherein receiving the sidelink data message further comprises:
rate-matching the reception of the sidelink data message around the second resource elements on which the one or more bursts of sidelink positioning reference signals are received.

28. The method of claim 22, further comprising:
receiving, from a sidelink UE, a sidelink control block identifying a first sidelink positioning reference signal burst pattern that is to be transmitted by the sidelink UE, the sidelink control block further scheduling the sidelink data message that is to be transmitted by the sidelink UE.

29. An apparatus for wireless communication at a user equipment (UE), comprising:
a processor;
memory coupled with the processor; and
instructions stored in the memory and executable by the processor to cause the apparatus to:
identify one or more sidelink positioning reference signal burst patterns identifying one or more bursts of sidelink positioning reference signals that are to be transmitted by either the UE or by other sidelink UEs;
scheduling transmission of a sidelink data message to occur during a same time period that includes the one or more bursts of sidelink positioning reference signals; and
transmit the sidelink data message via first resource elements that are different from second resource elements on which the one or more bursts of sidelink positioning reference signals are transmitted.

30. An apparatus for wireless communication at a first user equipment (UE), comprising:
a processor;
memory coupled with the processor; and
instructions stored in the memory and executable by the processor to cause the apparatus to:
identify one or more sidelink positioning reference signal burst patterns identifying one or more bursts of sidelink positioning reference signals to be transmitted by respective sidelink UEs;
receive, from a second UE, a sidelink data message during a same time period that includes the one or more bursts of sidelink positioning reference signals, the sidelink data message received via first resource elements that are different from second resource elements on which the one or more bursts of sidelink positioning reference signals are received; and
determine a position of the first UE based at least in part on receiving the one or more bursts of sidelink positioning reference signals.
